(19) United States
(12) Patent Application Publication
(10) Pub. No.: US 2022/0051633 A1
(43) Pub. Date: Feb. 17, 2022

(54) PIXEL CIRCUIT AND DRIVING METHOD THEREOF

(71) Applicant: Shanghai Tianma AM-OLED Co., Ltd., Shanghai (CN)

(72) Inventors: Yue LI, Shanghai (CN); Xingyao Zhou, Shanghai (CN); Mengmeng Zhang, Shanghai (CN); Gaojun Huang, Shanghai (CN); Ling Xu, Shanghai (CN)

(73) Assignee: Shanghai Tianma AM-OLED Co., Ltd., Shanghai (CN)

(21) Appl. No.: 17/515,771

(22) Filed: Nov. 1, 2021

(30) Foreign Application Priority Data
Jul. 29, 2021 (CN) 202110864272.6

(51) Int. Cl. G09G 3/3291; G09G 3/3266

(52) U.S. Cl. CPC G09G 3/3291; G09G 2330/023; G09G 2300/0819; G09G 3/3266

(57) ABSTRACT

Provided are a pixel circuit and a driving method, a display panel, and a display device. The pixel circuit includes a drive transistor, a node control device, a data write device, a light emission control device, a light-emitting element, a reset signal terminal, a data signal terminal, and a first power supply terminal. The node control device is configured to: in a reset stage, store a reset signal of the reset signal terminal and reset a gate of the drive transistor; and in a light emission stage, control a power signal of the first power supply terminal to be written to the gate of the drive transistor. The data write device is configured to, in a data write stage, write a data signal of the data signal terminal to the gate of the drive transistor and compensate a threshold voltage of the drive transistor to the gate.

### CROSS-REFERENCE TO RELATED APPLICATION

This application claims priority to Chinese Patent Application No. 202110864272.6 filed Jul. 29, 2021, the disclosure of which is incorporated herein by reference in its entirety.

### FIELD

Embodiments of the present disclosure relate to the field of display technologies and, in particular, to a pixel circuit and a driving method thereof, a display panel, and a display device.

### BACKGROUND

An organic light-emitting diode (OLED) display has become one of the most potential displays currently with advantages such as auto-luminescence, low drive voltage, high luminous efficiency, short response time, and flexible display.

An OLED element of the OLED display may be a voltage-driven element or a current-driven element. If the OLED element is the current-driven element, a corresponding pixel circuit needs to be disposed to provide a drive current for the OLED element so that the OLED element can emit light. The pixel circuit generally includes a drive transistor. Data signals are written to a gate of the drive transistor, threshold capture is performed, and the drive transistor provides a corresponding drive current according to a potential of the gate under the driving of a power supply voltage so that the OLED element emits light with a corresponding brightness. Since different luminous brightness levels of the OLED element correspond to different drive currents, and different drive currents correspond to gate potentials of the drive transistor, that is, different drive currents correspond to different data signals. When the OLED element has a relatively large brightness variation range, data signals with a relatively large voltage variation range need to be provided to the gate of the drive transistor, which is not conductive to the low power consumption of the pixel circuit and thus not conductive to the low power consumption of a display panel including the pixel circuit.

### SUMMARY

In view of the preceding problems, embodiments of the present disclosure provide a pixel circuit and a driving method thereof, a display panel, and a display device, to reduce the power consumption of the pixel circuit, reducing the power consumption of the display panel and the display device including the pixel circuit.

In one embodiment of the present disclosure provide a pixel circuit. The pixel circuit includes a drive transistor, a node control device, a data write device, a light emission control device, a light-emitting element, a reset signal terminal, a data signal terminal, and a first power supply terminal. The node control device is configured to: in a reset stage, store a reset signal of the reset signal terminal and reset a gate of the drive transistor and in a light emission stage, control a power signal of the first power supply terminal to be written to the gate of the drive transistor. The data write device is configured to, in a data write stage, write a data signal of the data signal terminal to the gate of the drive transistor and compensate a threshold voltage of the drive transistor to the gate of the drive transistor. The light emission control device is configured to, in the light emission stage, control a drive current generated by the drive transistor according to a potential of the gate of the drive transistor to be provided to the light-emitting element to drive the light-emitting element to emit light.

In another embodiment of the present disclosure further provide a driving method of a pixel circuit, where the driving method of a pixel circuit is used for driving the pixel circuit, where the pixel circuit includes a drive transistor, a node control device, a data write device, a light emission control device, a light-emitting element, a reset signal terminal, a data signal terminal, and a first power supply terminal, where the driving method of a pixel circuit includes steps described below. In a reset stage, the node control device writes a reset signal of the reset signal terminal to a gate of the drive transistor to reset the gate of the drive transistor. In a data write stage, the data write device controls a data signal of the data signal terminal to be written to the gate of the drive transistor and compensates a threshold voltage of the drive transistor to the gate of the drive transistor. In a light emission stage, the node control device controls a positive power signal of the first power supply terminal to be written to the gate of the drive transistor; the light emission control device controls a drive current generated by the drive transistor according to a potential of the gate of the drive transistor to be provided to the light-emitting element to drive the light-emitting element to emit light.

In yet another embodiment of the present disclosure further provide a display panel. The display panel includes the preceding pixel circuit.

In one embodiment of the present disclosure further provide a display device. The display device includes the preceding display panel.

### BRIEF DESCRIPTION OF DRAWINGS

FIG. 1 is a structure diagram of a pixel circuit according to an embodiment of the present disclosure;

FIG. 2 is a structure diagram of another pixel circuit according to an embodiment of the present disclosure;

FIG. 3 is a specific circuit diagram of a pixel circuit according to an embodiment of the present disclosure;

FIG. 4 is a specific circuit diagram of another pixel circuit according to an embodiment of the present disclosure;

FIG. 5 is a driving timing diagram of the pixel circuit corresponding to FIG. 3;

FIG. 6 is a specific circuit diagram of another pixel circuit according to an embodiment of the present disclosure;

FIG. 7 is a driving timing diagram of the pixel circuit corresponding to FIG. 6;

FIG. 8 is a specific circuit diagram of another pixel circuit according to an embodiment of the present disclosure;

FIG. 9 is a driving timing diagram of the pixel circuit corresponding to FIG. 8;

FIG. 10 is a specific circuit diagram of another pixel circuit according to an embodiment of the present disclosure;

FIG. 11 is a driving timing diagram of the pixel circuit corresponding to FIG. 10;

FIG. 12 is a structure diagram of another pixel circuit according to an embodiment of the present disclosure;

FIG. 13 is a driving timing diagram of the pixel circuit corresponding to FIG. 12;

FIG. 14 is a specific circuit diagram of another pixel circuit according to an embodiment of the present disclosure;

FIG. 15 is a driving timing diagram of the pixel circuit corresponding to FIG. 14;

FIG. 16 is a top diagram of a pixel circuit according to an embodiment of the present disclosure;

FIGS. 17 to 22 are structure diagrams of film layers of the pixel circuit corresponding to FIG. 16;

FIG. 23 is a sectional diagram of a pixel circuit according to an embodiment of the present disclosure;

FIG. 24 is a top diagram of another pixel circuit according to an embodiment of the present disclosure;

FIG. 25 is a sectional diagram of the pixel circuit corresponding to FIG. 24;

FIG. 26 is a top diagram of another pixel circuit according to an embodiment of the present disclosure;

FIGS. 27 to 32 are structure diagrams of film layers of the pixel circuit corresponding to FIG. 26;

FIG. 33 is a top diagram of another pixel circuit according to an embodiment of the present disclosure;

FIGS. 34 to 39 are structure diagrams of film layers of the pixel circuit corresponding to FIG. 33;

FIG. 40 is a top diagram of another pixel circuit according to an embodiment of the present disclosure;

FIGS. 41 to 46 are structure diagrams of film layers of the pixel circuit corresponding to FIG. 40;

FIG. 47 is a specific circuit diagram of another pixel circuit according to an embodiment of the present disclosure;

FIG. 48 is a driving timing diagram of the pixel circuit corresponding to FIG. 47;

FIG. 49 is a specific circuit diagram of another pixel circuit according to an embodiment of the present disclosure;

FIG. 50 is a driving timing diagram of a pixel circuit according to an embodiment of the present disclosure;

FIG. 51 is a specific circuit diagram of another pixel circuit according to an embodiment of the present disclosure;

FIG. 52 is a specific circuit diagram of another pixel circuit according to an embodiment of the present disclosure;

FIG. 53 is a flowchart of a driving method of a pixel circuit according to an embodiment of the present disclosure;

FIG. 54 is a structure diagram of a display panel according to an embodiment of the present disclosure; and

FIG. 55 is a structure diagram of a display device according to an embodiment of the present disclosure.

### DETAILED DESCRIPTION

The present disclosure is further described hereinafter in detail in conjunction with drawings and embodiments. It is to be understood that embodiments described hereinafter are intended to explain the present disclosure and not to limit the present disclosure. Additionally, it is to be noted that for ease of description, only part, not all, of structures related to the present disclosure are illustrated in the drawings.

When a gray scale represents a brightness level of a light-emitting element, the luminous brightness of the light-emitting element may vary in a gray scale range of 0 to 255 so that when the luminous brightness of the light-emitting element presents different brightness levels, data signals with different voltages need to be written to a gate of a drive transistor of a pixel circuit. In an embodiment, when a voltage of a data signal corresponding to 0 gray scale is a first voltage and a voltage of a data signal corresponding to 255 gray scale is a second voltage, voltages of data signals provided to the gate of the drive transistor vary in a range of the first voltage to the second voltage. In addition, when the first voltage and the second voltage are both relatively large values, the data signals provided to the gate of the drive transistor vary in a range of relatively large voltages. Since the power consumption of the pixel circuit is positively correlated with the voltage of the data signal, that is, the greater the voltage of the provided data signal is, the greater the power consumption of the pixel circuit is. Therefore, how to ensure that the light-emitting element presents the light of the corresponding brightness level, the power consumption of the pixel circuit is reduced has become a problem to be solved urgently.

To solve the preceding problem, embodiments of the present disclosure provide a pixel circuit. The pixel circuit includes a drive transistor, a node control device, a data write device, a light emission control device, a light-emitting element, a reset signal terminal, a data signal terminal, and a first power supply terminal. The node control device is configured to: in a reset stage, store a reset signal of the reset signal terminal and reset a gate of the drive transistor; and in a light emission stage, control a power signal of the first power supply terminal to be written to the gate of the drive transistor. The data write device is configured to, in a data write stage, write a data signal of the data signal terminal to the gate of the drive transistor and compensate a threshold voltage of the drive transistor to the gate of the drive transistor. The light emission control device is configured to, in the light emission stage, control a drive current generated by the drive transistor according to a potential of the gate of the drive transistor to be provided to the light-emitting element to drive the light-emitting element to emit light.

In the preceding embodiments, the node control device writes the power signal of the first power supply terminal to the gate of the drive transistor in the light emission stage, and the potential of the gate of the drive transistor is raised. In this manner, the drive transistor can provide a corresponding drive current according to the potential of the gate of the drive transistor so that the light-emitting element can present corresponding brightness just by writing data signals that vary within a relatively small voltage range to the gate of the drive transistor in the data write stage, which is conductive to the low power consumption of the pixel circuit and thus conductive to the low power consumption of the display panel and the display device. At the same time, when a voltage of the data signal written to the gate of the drive transistor in the data write stage is relatively small, the data signal with the relatively small voltage can be quickly written to the gate of the drive transistor so that the time for writing the data signal can be shortened and thus the problem of lack of data write time during high-frequency driving can be improved, improving the display effect of the display panel. On the other hand, the node control device provides the reset signal of the reset signal terminal to the gate of the drive transistor to reset the gate of the drive transistor in the reset stage so that it is ensured that the data write device can write the data signal of the data signal terminal to the gate of the drive transistor in the data write stage. Moreover, when writing the data signal to the gate of the drive transistor in the data write stage, the data write device compensates the threshold voltage of the drive transistor to the gate of the drive transistor so that the drive current generated by the drive transistor according to the potential of the gate of the drive transistor is independent of the threshold voltage of the drive transistor.

In this manner, when the light emission control device controls the drive current generated by the drive transistor to be provided to the light-emitting element to drive the light-emitting element to emit light in the light emission stage, the fluctuation of the threshold voltage of the drive transistor can be prevented from affecting the luminous brightness of the light-emitting element, which is conductive to improving the display uniformity of the display panel.

The embodiments of the present disclosure are described clearly and completely hereinafter in conjunction with the drawings in the embodiments of the present disclosure.

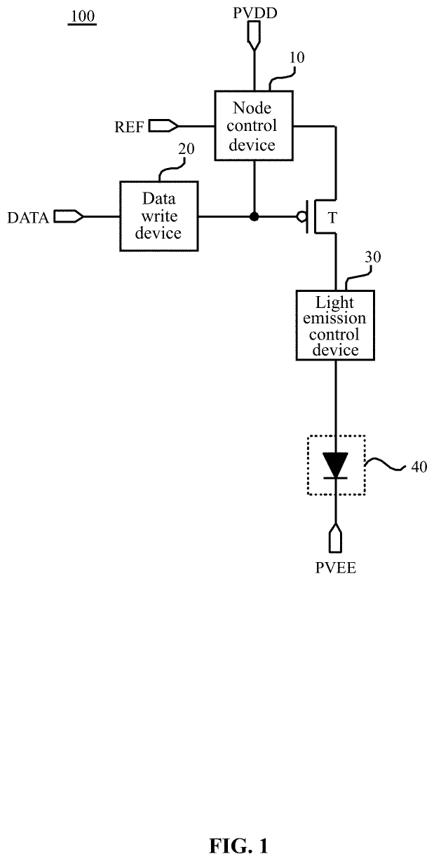

FIG. 1 is a structure diagram of a pixel circuit according to an embodiment of the present disclosure. As shown in FIG. 1, a pixel circuit 100 includes a drive transistor T, a node control device 10, a data write device 20, a light emission control device 30, a light-emitting element 40, a reset signal terminal REF, a data signal terminal DATA, and a first power supply terminal PVDD. In a reset stage, the node control device 10 stores a reset signal of the reset signal terminal REF and resets a gate of the drive transistor T to prepare for the writing of subsequent data signals. In a data write stage, the data write device 20 writes a data signal of the data signal terminal DATA to the gate of the drive transistor T. At the same time, in the data write stage, the data write device 20 compensates a threshold voltage of the drive transistor T to the gate of the drive transistor T so that at the end of the data write stage, a gate potential Vg of the drive transistor T includes at least the threshold voltage of the drive transistor and the data signal of the data signal terminal DATA. In a light emission stage, a drive current Id generated by the drive transistor T is as following:

Id=K*(Vg−Vs−Vth)²

K denotes a coefficient related to a structure of the drive transistor T, Vs denotes a first electrode potential of the drive transistor, and Vth denotes the threshold voltage of the drive transistor T. After the data write stage, the gate potential Vg of the drive transistor T includes the threshold voltage Vth of the drive transistor to offset the contribution of the threshold voltage Vth on the drive current Id so that the drive current generated by the drive transistor T is independent of the threshold voltage Vth of the drive transistor, and the threshold drift of the drive transistor can be prevented from affecting the drive current Id provided by the drive transistor T in the light emission stage. In this manner, when the light emission control device 30 controls the drive current generated by the drive transistor T to be provided to the light-emitting element 40, it is ensured that the light-emitting element 40 can present a corresponding luminous brightness and the light-emitting effect of the light-emitting element 40 can be improved; in addition, when the pixel circuit 100 is applied to a display panel, the display effect of the display panel can be improved.

It is to be understood that the light-emitting element needs to present different luminous brightness, and the voltages of the data signals written to the gate of the drive transistor in the data write stage are different. When a channel type of the drive transistor is P-type, the lower the luminous brightness of the light-emitting element is, the smaller the drive current that the drive transistor needs to provide is, and the higher the potential of the gate of the drive transistor is so that in the data write stage, the greater the voltage written by the data write device to the gate of the drive transistor is, the greater the voltage of the data signal provided to the data signal terminal is; on the contrary, the higher the luminous brightness of the light-emitting element is, in the data write stage, the smaller the voltage written by the data write device to the gate of the drive transistor T is, the smaller the voltage of the data signal provided to the data signal terminal is. When the channel type of the drive transistor is N-type, the lower the luminous brightness of the light-emitting element is, the lower the voltage of the data signal provided to the data signal terminal is; the higher the luminous brightness of the light-emitting element is, the higher the voltage of the data signal provided to the data signal terminal is. However, the power consumption of the pixel circuit is related to the voltage of the data signal provided to the data signal terminal of the pixel circuit. Therefore, when the voltage of the data signal varies within a relatively large voltage range, whether the data signal corresponding to the relatively high display brightness or the data signal corresponding to the relatively low display brightness has corresponding power consumption; in addition, under the same condition, the power consumption of the pixel circuit increases as the voltage of the data signal increases.

With continued reference to FIG. 1, a data signal with a relatively small voltage is provided to the data signal terminal DATA in the data write stage. Although the data signal with the relatively small voltage does not match with the brightness that the light-emitting element 40 should present, in the light emission stage, the node control device 10 can control the power signal of the first power supply terminal PVDD to be written to the gate of the drive transistor T to raise the potential of the gate of the drive transistor T so that the potential of the gate of the drive transistor T can match with the drive current that the drive transistor should provide and thus match with the luminous brightness that the light-emitting element 40 should present. In this manner, in the light emission stage, only a data signal with a relatively small voltage needs to be provided to the data signal terminal DATA to satisfy the light emission requirements of the light-emitting element 40, which is conductive to reducing the power consumption of the pixel circuit 100 and reducing the power consumption of the display panel including the pixel circuit 100.

Correspondingly, a high-frequency driving mode refers to a driving mode in which a display panel has a relatively high refresh frequency. In this case, a driving period of a pixel circuit in the display panel is relatively short so that the reset stage, the data write stage, and the light emission stage of the pixel circuit are shortened accordingly. Therefore, in the data write stage, the data signal needs to be quickly and accurately written to the gate of the drive transistor to ensure that the gate of the drive transistor has a enough voltage signal to generate a corresponding drive current and the light-emitting element is driven to present light with a corresponding brightness level. In addition, in the data write stage, the higher the voltage of the data signal that needs to be written to the gate of the drive transistor is, the longer the time required for the data write stage is. Therefore, in the data write stage, the smaller the voltage of the data signal written to the drive transistor T is, the less the required time is so that the time of the data write stage and the time of drive transistor threshold capture (that is, threshold compensation) can be correspondingly shortened, the problem of lack of charging time in the high-frequency driving mode can be improved, and thus an excellent display effect of the display panel in the high-frequency driving mode can be ensured.

It is to be understood that in the data write stage in the embodiments of the present disclosure, the data signal written by the data write device to the gate of the drive transistor has a relatively small voltage so that the data signal only needs to vary within a relatively small voltage range, that is, whether the voltage of the data signal corresponding to the relatively high luminous brightness or the voltage of the data signal corresponding to the relatively low luminous brightness has a relatively small voltage, that is, no matter what luminous brightness the light-emitting element needs to present, the voltage of the data signal of the data signal terminal is relatively small so that in a brightness range from the relatively high brightness to the relatively low brightness, the power consumption of the pixel circuit can be reduced and the problem of lack of charging time in the high-frequency driving mode can be improved.

In an embodiment, with continued reference to FIG. 1, the node control device 10 is further configured to, in the reset stage, write the reset signal of the reset signal terminal REF to a first electrode of the drive transistor T to reset the first electrode of the drive transistor T. In this manner, in the reset stage, the gate and the first electrode of the drive transistor T can be reset at the same time, that is, each of the gate and the first electrode of the drive transistor T is the reset signal of the reset signal terminal REF so that in the reset stage of each driving cycle, the gate and the first electrode of the drive transistor T can be in a fixed state to prevent the hysteresis effect of the drive transistor T, which is conductive to the writing of the data signal in the data write stage, improving the accuracy of the data signal written to the gate of the drive transistor T, improving the accuracy of the luminous brightness of the light-emitting element 40, and thus improving the display effect of the display panel.

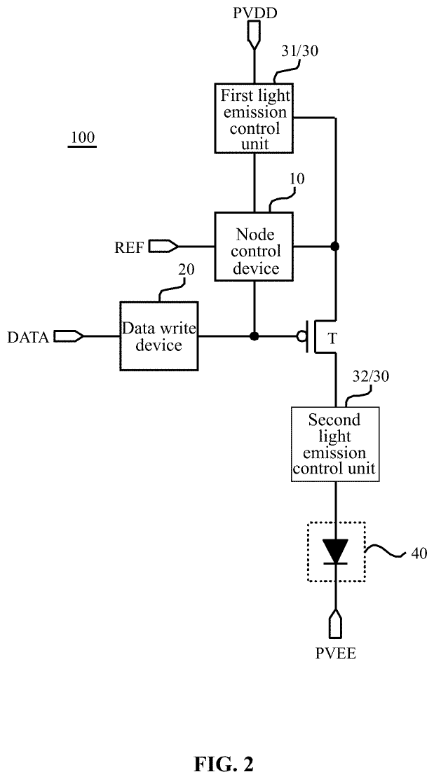

In an embodiment, FIG. 2 is a structure diagram of another pixel circuit according to an embodiment of the present disclosure. As shown in FIG. 2, the pixel circuit 100 further includes a second power supply terminal PVEE; in this case, the light emission control device 30 includes a first light emission control unit 31 and a second light emission control unit 32. In this case, the node control device 10 is electrically connected to the reset signal terminal REF, the first light emission control unit 31, the first electrode of the drive transistor T, and the gate of the drive transistor T, respectively; the first light emission control unit 31 is electrically connected to the first electrode of the drive transistor T and the first power supply terminal PVDD; the second light emission control unit 32 is electrically connected to a second electrode of the drive transistor T and an anode of the light-emitting element 40, respectively; a cathode of the light-emitting element 40 is electrically connected to the second power supply terminal PVEE.

In an embodiment, in the reset stage, the node control device 10 may store the reset signal of the reset signal terminal REF and reset the gate and the first electrode of the drive transistor T to prepare for the writing of subsequent data signals. In the light emission stage, the node control device 10 may receive the power signal of the first power supply terminal PVDD through the first light emission control unit 31 and write the power signal to the gate of the drive transistor T to raise the potential of the gate of the drive transistor T so that the drive current generated by the drive transistor T according to the potential of the gate of the drive transistor T can match with the luminous brightness that the light-emitting element 40 needs to present. At the same time, in the light emission stage, the first light emission control unit 31 and the second light emission control unit 32 perform controlling so that a current path is formed between the first power supply terminal PVDD and the second power supply terminal PVEE, and thus the drive current generated by the drive transistor T is provided to the light-emitting element 40 to drive the light-emitting element 40 to accurately emit light.

It is to be noted that in the embodiments of the present disclosure, the node control device, the data write device, the first light emission control unit, and the second light emission control unit may all include active devices and/or passive devices, where the active devices may include and are not limited to transistors, and the passive devices may include and are not limited to resistors, capacitors, and inductors. On the premise that the functions of each functional device can be achieved, the embodiments of the present disclosure do not specifically limit the structure of each functional device.

The structure of each functional device in the embodiments of the present disclosure is described hereinafter in conjunction with examples.

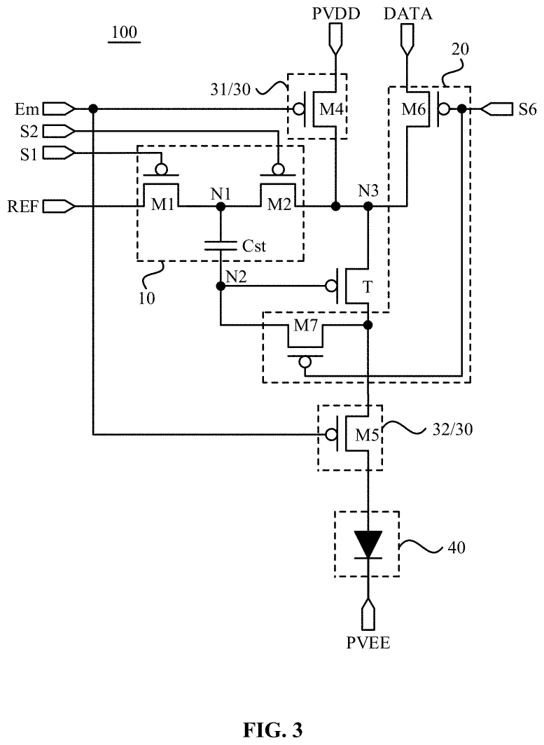

In an embodiment, FIG. 3 is a specific circuit diagram of a pixel circuit according to an embodiment of the present disclosure. As shown in FIG. 3, the pixel circuit 100 further includes a first scanning terminal S1 and a second scanning terminal S2. In this case, the node control device 10 may include a first transistor M1, a second transistor M2, and a storage capacitor Cst. A gate of the first transistor M1 is electrically connected to the first scanning terminal S1, and a gate of the second transistor M2 is electrically connected to the second scanning terminal S2. A first electrode of the first transistor M1 is electrically connected to the reset signal terminal REF. A second electrode of the first transistor M1, a first electrode of the second transistor M2, and a first electrode plate of the storage capacitor Cst are electrically connected to a first node N1. A second electrode plate of the storage capacitor Cst and the gate of the drive transistor T are electrically connected to a second node N2. A second electrode of the second transistor M2 and the first electrode of the drive transistor T are electrically connected to a third node N3. The first light emission control unit 31 and the node control device 10 are electrically connected to the third node N3. In this case, the first transistor M1 may be turned on or off under the control of a first scanning signal of the first scanning terminal S1, and the second transistor M2 may be turned on or off under the control of the second scanning terminal S2.

In the reset stage, a first scanning signal Scan1 of the first scanning terminal S1 may control the first transistor M1 to be turned on, and a second scanning signal Scan2 of the second scanning terminal S2 may control the second transistor M2 to be turned on so that a reset signal Vref of the reset signal terminal REF can be transmitted to the first node N1 through the turned-on first transistor M1. Vref is stored in the storage capacitor Cst to reset the first node N1 and the storage capacitor Cst, and the reset signal Vref is coupled to the second node N2 through the storage capacitor Cst to reset the gate of the drive transistor T; in this case, the reset signal Vref is also transmitted to the third node N3 through the turned-on second transistor M2 to reset the first electrode of the drive transistor T.

In the data write stage, the first scanning signal Scan1 of the first scanning terminal S1 may control the first transistor M1 to remain on and a potential of the first node N1 to remain as Vref; the second scanning signal Scan2 of the second scanning terminal S2 may control the second transistor M2 to be in an off state, and the data write device 20 writes a data signal Vdata of the data signal terminal DATA to the second node N2 and compensates the threshold voltage Vth of the drive transistor T to the second node N2. In this manner, at the end of the data write stage, a potential of the first electrode plate of the storage capacitor Cst is Vref, and a potential of the second electrode plate of the storage capacitor Cst is Vdata+Vth so that two ends of the storage capacitor Cst remain a relatively balanced state.

Correspondingly, the first light emission control unit 31 and the node control device 10 are electrically connected to the third node N3. Therefore, in the light emission stage, the first light emission control unit 31 may control a power signal Vdd of the first power supply terminal PVDD to be transmitted to the third node N3. At the same time, the first scanning signal Scan1 of the first scanning terminal S1 controls the first transistor M1 to be turned off, and the second scanning signal Scan2 of the second scanning terminal S2 controls the second transistor M2 to be turned on so that the power signal Vdd is transmitted to the first node N1 through the turned-on second transistor M2 and the potential of the first node N1 varies from Vref to Vdd. In this case, the potential of the first node N1 rises by ΔV=Vdd−Vref. In addition, due to the coupling effect of the storage capacitor Cst, the potential of the second node N2 also rises by ΔV so that the object of raising the potential of the second node N2 is achieved. That is, in the light emission stage, the potential of the gate of the drive transistor T can be raised so that the drive transistor T can generate a corresponding drive current according to the raised potential of the gate of the drive transistor T to drive the light-emitting element 40 to emit light.

When the first light emission control unit 31 includes a first light emission control transistor M4, a first electrode of the first light emission control transistor M4 is electrically connected to the first power supply terminal PVDD and a second electrode of the first light emission control transistor M4 is electrically connected to the third node.

It is to be noted that the electrical connection between transistors, the electrical connection between the transistor and the signal terminal, and the electrical connection between other devices that need to be electrically connected in the embodiments of the present disclosure may all be direct contact connection, connection through corresponding signal lines, or connection through corresponding devices (such as transistors). The embodiments of the present disclosure do not limit the specific implementation of the electrical connection under the premise that the embodiments of the present disclosure can be achieved.

It is to be further noted that FIG. 3 is only an exemplary drawing of the embodiments of the present disclosure. FIG. 3 only exemplarily shows that the first light emission control unit 31 and the node control device 10 are electrically connected to the third node N3, and in the embodiments of the present disclosure, the first light emission control unit may also be electrically connected to the first node with the node control device.

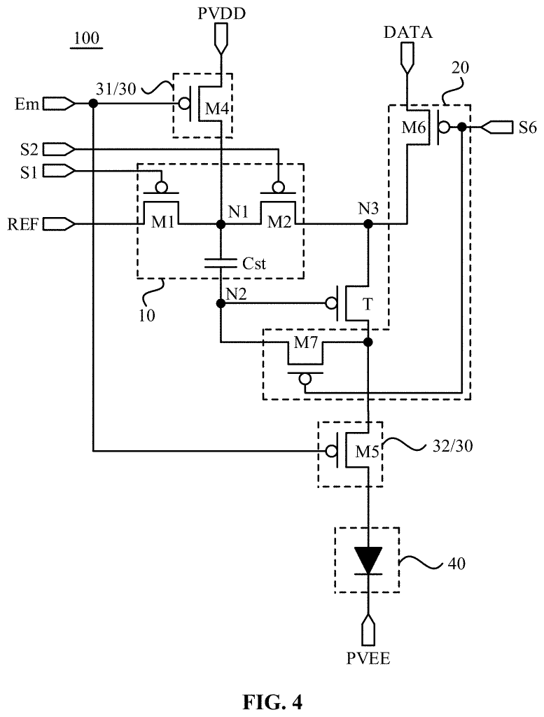

In an embodiment, FIG. 4 is a specific circuit diagram of another pixel circuit according to an embodiment of the present disclosure. For the same parts in FIG. 4 and FIG. 3, reference may be made to the preceding description of FIG. 3, which is not repeated herein. Only the differences between FIG. 4 and FIG. 3 are exemplified. As shown in FIG. 4, when the first light emission control unit 31 and the node control device 10 are electrically connected to the first node N1, the first light emission control unit 31 may be electrically connected to the first electrode of the drive transistor T through the second transistor M2. In this manner, in the light emission stage, the first light emission control unit 10 may control the power signal Vdd of the first power supply terminal PVDD to be transmitted to the first node N1 so that the potential of the first node N1 rises by ΔV. In this case, due to the coupling effect of the storage capacitor Cst, the potential of the second node N2 also rises by ΔV so that the object of raising the potential of the gate of the drive transistor T can be achieved. At the same time, the second transistor M2 is turned on under the control of the second scanning signal of the second scanning terminal S2 so that the power signal Vdd is transmitted to the third node N3 through the turned-on second transistor M2 to ensure that a current path can be formed between the first power supply terminal PVDD and the second power supply terminal PVEE.

When the first light emission control unit 31 includes the first light emission control transistor M4, the first electrode of the first light emission control transistor M4 is electrically connected to the first power supply terminal PVDD and the second electrode of the first light emission control transistor M4 is electrically connected to the first node.

It is to be understood that in two connection manners of the first light emission control unit 31 and the node control device 10 shown in FIGS. 3 and 4, the turned on or off of the first transistor M1 and the second transistor M2 are the same. Therefore, when the channel types of the first transistor M1 and the second transistor M2 remain unchanged, the driving timing corresponding to FIG. 3 and the driving timing corresponding to FIG. 4 are the same.

For ease of description, unless otherwise specified, in the embodiments of the present disclosure, the case where the first light emission control unit 31 and the node control device 30 are electrically connected to the third node N3 (as shown in FIG. 3) is used as an example for description of the embodiments of the present disclosure.

As shown in FIG. 3, the pixel circuit 100 further includes a sixth scanning terminal S6 and a light emission control terminal Em. The first light emission control unit 31 includes the first light emission control transistor M4, and the second light emission control unit 32 includes a second light emission control transistor M5. The data write device 20 includes a data write transistor M6 and a threshold compensation transistor M7. A gate of the first light emission control transistor M4 and a gate of the second light emission control transistor M5 are electrically connected to the light emission control terminal Em, and a gate of the data write transistor M6 and a gate of the threshold compensation transistor M7 are electrically connected to the sixth scanning terminal S6. The first electrode of the first light emission control transistor M4 is electrically connected to the first power supply terminal PVDD, and the second electrode of the first light emission control transistor M4, the first electrode of the drive transistor T, and the second electrode of the second transistor M2 are electrically connected to the third node N3. A first electrode of the second light emission control transistor M5 is electrically connected to the second electrode of the drive transistor T, and a second electrode of the second light emission control transistor M5 is electrically connected to the anode of the light-emitting element 40. A first electrode of the data write transistor M6 is electrically connected to the data signal terminal DATA, a second electrode of the data write transistor M6 is electrically connected to the first electrode of the drive transistor T, a first electrode of the threshold compensation transistor M7 is electrically connected to the second electrode of the drive transistor T, and a second electrode of the threshold compensation transistor M7 is electrically connected to the gate of the drive transistor T. In this case, the first light emission control transistor M4 and the second light emission control transistor M5 are both turned on or off under the control of a light emission control signal Emit of the light emission control terminal Em, and the data write transistor M6 and the threshold compensation transistor M7 are both turned on or off under the control of a sixth scanning signal of the sixth scanning terminal S6.

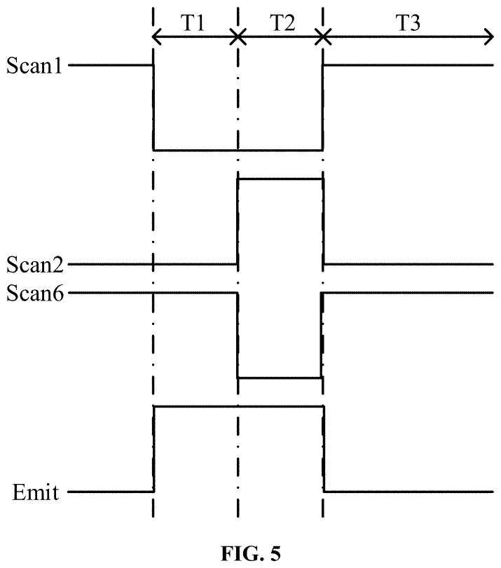

In an embodiment, the case where a channel type of each transistor in FIG. 3 is P-type is used as an example. FIG. 5 is a driving timing diagram of the pixel circuit corresponding to FIG. 3. In conjunction with FIGS. 3 and 5, the specific operation principle of the pixel circuit 100 is described below.

In a reset stage T1, the first scanning signal Scan1 of the first scanning terminal S1 is an enabling level capable of controlling the first transistor M1 to be turned on, the second scanning signal Scan2 of the second scanning terminal S2 is an enabling level capable of controlling the second transistor M2 to be turned on, a sixth scanning signal Scan6 of the sixth scanning terminal S6 is a non-enabling level capable of controlling the data write transistor M6 and the threshold compensation transistor M7 to be turned off, and the light emission control signal Emit of the light emission control terminal Em is a non-enabling level capable of controlling the first light emission control transistor M4 and the second light emission control transistor M5 to be turned off. In this case, the reset signal Vref of the reset signal terminal REF is transmitted to the first node N1 through the turned-on first transistor M1 to reset the first node N1; the reset signal Vref of the reset signal terminal REF is stored in the storage capacitor Cst and coupled to the second node N2 through the storage capacitor Cst to reset the second node N2, that is, to reset the gate of the drive transistor T; the reset signal Vref of the reset signal terminal REF is transmitted from the first node N1 to the third node N3 through the turned-on second transistor M2 to reset the first electrode of the drive transistor T. In this manner, the gate and the first electrode of the drive transistor T are both reset by the reset signal Vref so that the drive transistor T is restored from a bias state in a previous driving cycle to a non-bias state to prepare for the writing of the data signal. At the end of the reset stage T1, the potentials of the first node N1, the second node N2, and the third node N3 are all voltages of the reset signal Vref.

In a data write stage T2, the first scanning signal Scan1 of the first scanning terminal S1 controls the first transistor M1 to remain on, and the second scanning signal Scan2 of the second scanning terminal S2 becomes a non-enabling level that controls the second transistor M2 to be turned off, the sixth scanning signal Scan6 of the sixth scanning terminal S6 becomes an enabling level that controls the data write transistor M6 and the threshold compensation transistor M7 to be turned on, and the light emission control signal Emit of the light emission control terminal Em controls the first light emission control transistor M4 and the second light emission control transistor M5 to remain off. The data signal Vdata of the data signal terminal DATA is written to the second node N2 sequentially through the turned-on data write transistor M6, the drive transistor T, and the threshold compensation transistor M7 and stored in the storage capacitor Cst until when the potential difference between the gate and the first electrode of the drive transistor T is the threshold voltage Vth of the drive transistor T, the drive transistor T is in a critical state of off so that at the end of the data write stage, a potential VN2 of the second node N2 is equal to Vdata+Vth; while the data signal Vdata is written, the threshold voltage of the drive transistor T is compensated to the second node N2. In addition, the reset signal Vref of the reset signal terminal Ref is transmitted to the first node N1 through the turned-on first transistor M1 so that the potential of the first node N1 is remained as the voltage of the reset signal Vref, that is, a potential VN1 of the first node N1 is equal to Vref. In the data write stage T2, the voltage of the data signal Vdata of the data signal terminal DATA is relatively small. When the drive transistor T directly generates the drive current Id according to the current potential of the second node N2 to drive the light-emitting element 40 to emit light, the luminous brightness presented by the light-emitting element 40 is not the luminous brightness that the light-emitting element 40 should actually present. However, the voltage of the data signal Vdata of the data signal terminal DATA is relatively small. Therefore, after charged, the second node N2 can quickly have a potential of Vdata+Vth so that the charging time can be shortened to satisfy the charging requirements of high-frequency driving, and it is ensured that the pixel circuit 100 has relatively low power consumption in this stage.

In a light emission stage T3, the first scanning signal Scan1 of the first scanning terminal S1 becomes a non-enabling level that controls the first transistor M1 to be turned off, the second scanning signal Scan2 of the second scanning terminal S2 becomes an enabling level that controls the second transistor M2 to be turned on, the sixth scanning signal Scan6 of the sixth scanning terminal S6 becomes a non-enabling level that controls the data write transistor M6 and the threshold compensation transistor M7 to be turned off, and the light emission control signal Emit of the light emission control terminal Em becomes an enabling level that controls the first light emission control transistor M4 and the second light emission control transistor M5 to be turned on. In this case, the power signal Vdd of the first power supply terminal PVDD is transmitted to the third node N3 through the turned-on first light emission control transistor M4 and transmitted to the first node N1 through the turned-on second transistor M2 so that the potential of the first node N1 varies from Vref to Vdd and the potential of the first node N1 rises by ΔV=Vdd−Vref Due to the coupling effect of the storage capacitor Cst, the potential of the second node N2 also rises by ΔV=Vdd−Vref so that the potential of the second node N2 varies from Vdata+Vth to Vdata+Vth+Vdd−Vref and the potential of the second node N2 rises. At the same time, the potential of the third node N3 is the voltage of the power signal Vdd so that a voltage difference Vgs between the gate and the first electrode of the drive transistor T is as following:

$$Vgs = Vg - Vs = Vdata + Vth + Vdd - Vref - Vdd = Vdata + Vth - Vref .$$

When the drive transistor T is a P-type transistor, a conduction condition of the drive transistor is that Vgs is less than the threshold voltage Vth of the drive transistor, Vth satisfies:

Vdata+Vth−Vef<Vth.

### That is, Vdata−Vref<0.

In this case, the voltage of the reset signal Vref of the reset signal terminal REF may be greater than the voltage of the data signal Vdata of the data signal terminal DATA. That is, under the premise that the gate and the first electrode of the drive transistor T are reset when the data signal Vdata is a relatively small positive value, the voltage of the reset signal Vref of the reset signal terminal REF may be any positive value greater than the voltage of the data signal Vdata; or when the voltage of the data signal Vdata of the data signal terminal DATA is a negative value, the voltage of the reset signal Vref of the reset signal terminal REF may be a negative value greater than Vdata. In this manner, the drive transistor T can be turned on again, and the drive current Id generated by the drive transistor T according to the raised potential of the second node N2 is satisfies:

$$\begin{matrix}Id = K * {( Vg - Vs - Vth )}^{2} \\ = K * {( Vdata + Vth + Vdd - Vref - Vdd - Vth )}^{2} \\ = K * {( Vdata - Vref )}^{2} .\end{matrix}$$

K denotes a coefficient related to the structure of the drive transistor T. In this manner, the drive current Id generated by the drive transistor T is independent of the threshold voltage of the drive transistor, and the drive current Id is provided to the anode of the light-emitting element 40 to charge the anode of the light-emitting element 40 until when the voltage difference between the potential of the anode of the light-emitting element 40 and the voltage of a power signal Vee of the second power supply terminal PVEE received by the cathode is greater than a light-emitting threshold voltage of the light-emitting element 40, the light-emitting element 40 starts to emit light, and at this time, the luminous brightness of the light-emitting element 40 is consistent with the luminous brightness that the light-emitting element 40 should present so that under the premise that the power consumption of the pixel circuit 100 is reduced, the light emission accuracy of the light-emitting element 40 can be improved and the display effect of the display panel can be improved.

It is to be noted that FIG. 3 only exemplarily shows that the channel type of each transistor is P-type. The enabling level of the P-type transistor is a low level and the non-enabling level of the P-type transistor is a high level. In the embodiments of the present disclosure, the channel type of each transistor may also be N-type. The enabling level of the N-type transistor is a high level and the non-enabling level of the N-type transistor is a low level, that is, the N-type transistor is turned on when the signal received by the gate of the N-type transistor is a high-level signal, and the N-type transistor is turned off when the signal received by the gate of the N-type transistor is a low-level signal. Therefore, when the channel type of the transistor in the pixel circuit is N-type, it is only necessary to adaptively change the level signals of the first scanning terminal, the second scanning terminal, the sixth scanning terminal, and the light emission control terminal. The channel type of each transistor in the pixel circuit is not specifically limited in the embodiments of the present disclosure.

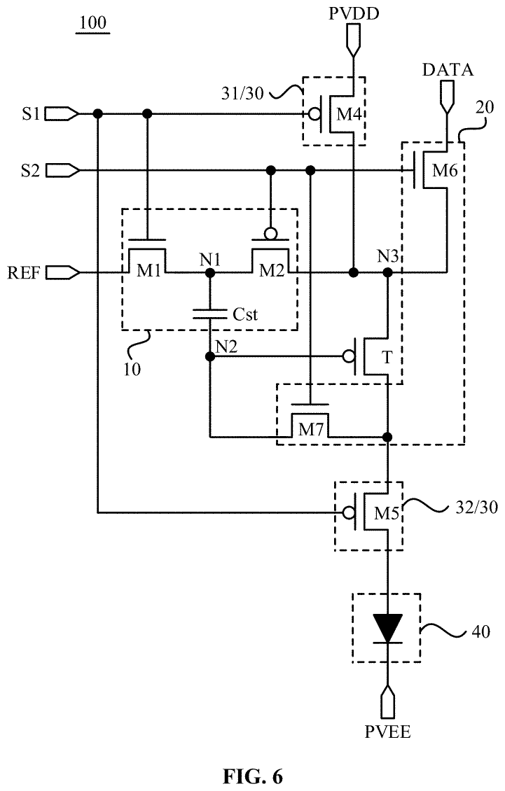

In an embodiment, FIG. 6 is a specific circuit diagram of another pixel circuit according to an embodiment of the present disclosure. As shown in FIG. 6, the channel types of the first transistor M1, the data write transistor M6, and the threshold compensation transistor M7 may be N-type, and the channel types of the second transistor M2, the first light emission control transistor M4, and the second light emission control transistor M5 may be P-type. That is, the channel type of the first transistor M1 may be different from the channel type of the first light emission control transistor M4, and the channel type of the second transistor M2 may be different from the channel type of the data write transistor M6.

In addition, the first transistor M1 is turned on in the reset stage and the data write stage and turned off in the light emission stage; and the first light emission control transistor M4 is turned off in the reset stage and the data write stage and turned on in the light emission stage. Therefore, when the channel type of the first transistor M1 is different from the channel type of the first light emission control transistor M4, the first scanning terminal S1 may be reused as the light emission control terminal Em so that when controlling the first transistor M1 to be turned on, the first scanning signal Scan1 of the first scanning terminal S1 can control the first light emission control transistor M4 to be turned off, and when controlling the first transistor M1 to be turned off, the first scanning signal Scan1 of the first scanning terminal S1 can control the first light emission control transistor M4 to be turned on. In this manner, the number of signal terminals in the pixel circuit 100 can be reduced, the structure of the pixel circuit 100 can be simplified, and the number of signals provided to the pixel circuit 100 can be reduced. The more types of the signals provided to the pixel circuit 100 are and the larger the number of the signals provided to the pixel circuit 100 is, the more complex a signal conversion circuit that needs to be involved is and the higher the cost is. Therefore, the number of the signals provided to the pixel circuit 100 is reduced, which is conductive to simplifying the structure of the display panel and reducing the cost of the display panel.

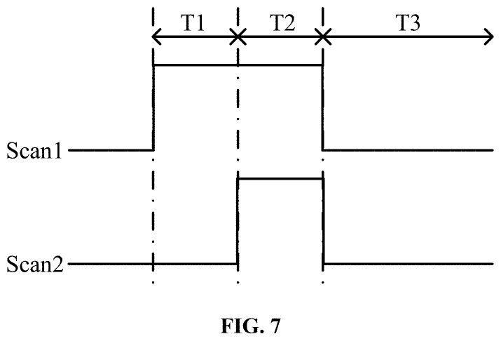

In an embodiment, FIG. 7 is a driving timing diagram of the pixel circuit corresponding to FIG. 6. In conjunction with FIGS. 6 and 7, in the reset stage T1 and the data write stage T2, the first scanning signal Scan1 of the first scanning terminal S1 is a high-level signal, and the high-level first scanning signal Scan1 controls the first transistor M1 to be in the on state and controls the first light emission control transistor M4 to be in the off state. In the light emission stage T3, the first scanning signal Scan1 of the first scanning terminal S1 becomes a low-level signal, and the low-level first scanning signal Scan1 controls the first light emission control transistor M4 to be in the on state and controls the first transistor M1 to be in the off state.

Similarly, the second transistor M2 is turned on in the reset stage and the light emission stage and turned off in the data write stage; and the data write transistor M6 is turned on in the data write stage and turned off in the reset stage and the light emission stage. Therefore, when the channel type of the second transistor M2 is different from the channel type of the data write transistor M6, the second scanning terminal S1 may be reused as the sixth scanning terminal S6 so that when controlling the second transistor M2 to be turned on, the second scanning signal Scan2 of the second scanning terminal S2 can control the data write transistor M6 to be turned off, and when controlling the second transistor M2 to be turned off, the second scanning signal Scan2 of the second scanning terminal S2 can control the data write transistor M6 to be turned on. In this manner, the number of the signal terminals in the pixel circuit 100 can be reduced, the structure of the pixel circuit 100 can be simplified, and the number of the signals provided to the pixel circuit 100 can be reduced, simplifying the structure of the display panel and reducing the cost of the display panel.

In an embodiment, with continued reference to FIGS. 6 and 7, in the reset stage T1, the second scanning signal Scan2 of the second scanning terminal S1 is a low-level signal, and the low-level second scanning signal Scan2 controls the second transistor M2 to be in the on state and controls the date write transistor M6 to be in the off state. In the data write stage T2, the second scanning signal Scan2 of the second scanning terminal S1 becomes a high-level signal, and the high-level second scanning signal Scan2 controls the data write transistor M6 to be in the on state and controls the second transistor M2 to be in the off state. In the light emission stage T2, the second scanning signal Scan2 of the second scanning terminal S1 becomes a low-level signal, and the low-level second scanning signal Scan2 controls the second transistor M2 to be in the on state and controls the data write transistor M6 to be in the off state.

It is to be noted that FIGS. 6 and 7 are only exemplary drawings of the embodiments of the present disclosure. FIG. 6 only exemplarily shows that the channel type of the first transistor M1 is N-type and the channel type of the first light emission control transistor M4 is P-type; and in the embodiments of the present disclosure, the channel type of the first transistor M1 may also be P-type, and at this time, the channel type of the first light emission control transistor M4 is N-type.

Similarly, FIG. 6 only exemplarily shows that the channel type of the second transistor M2 is P-type and the channel type of the data write transistor M6 is P-type; and in the embodiments of the present disclosure, the channel type of the second transistor M2 may also be N-type, and at this time, the channel type of the data write transistor M6 is N-type.

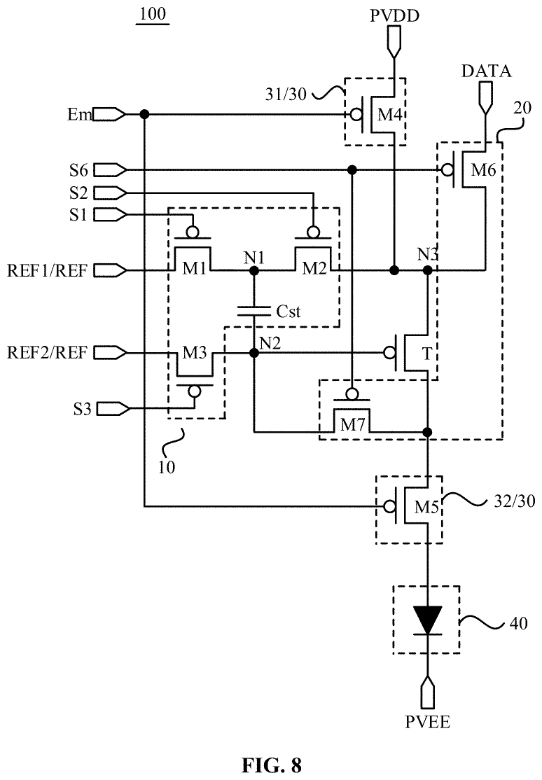

Based on the preceding embodiments, in an embodiment, FIG. 8 is a specific circuit diagram of another pixel circuit according to an embodiment of the present disclosure. For the same parts in FIG. 8 and FIG. 3, reference may be made to the preceding description of FIG. 3, which is not repeated herein. Only the differences between FIG. 8 and FIG. 3 are exemplified. As shown in FIG. 8, the pixel circuit 100 further includes a third scanning terminal S3; the node control device 10 further includes a third transistor M3, where a gate of the third transistor M3 is electrically connected to the third scanning terminal S3, a first electrode of the third transistor M3 is electrically connected to the reset signal terminal REF, and a second electrode of the third transistor M3 is electrically connected to the second node N2. In this case, the third transistor M3 may be turned on or off under the control of a third scanning signal of the third scanning terminal S3.

In the reset stage, the first scanning signal Scan1 of the first scanning terminal S1 may control the first transistor M1 to be turned on, the second scanning signal Scan2 of the second scanning terminal S2 may control the second transistor M2 to be turned on, and a third scanning signal Scan3 of the third scanning terminal S3 may control the third transistor M3 to be turned on so that the reset signal Vref of the reset signal terminal REF can be transmitted to the first node N1 through the turned-on first transistor M1 and stored in the storage capacitor Cst to reset the storage capacitor Cst and the first node N1; at the same time, the reset signal Vref can also be transmitted from the first node N1 to the third node N3 through the turned-on second transistor M2 to reset the first electrode of the drive transistor T, and the reset signal Vref of the reset signal terminal REF can be transmitted to the second node N2 through the turned-on third transistor M3 to reset the gate of the drive transistor T.

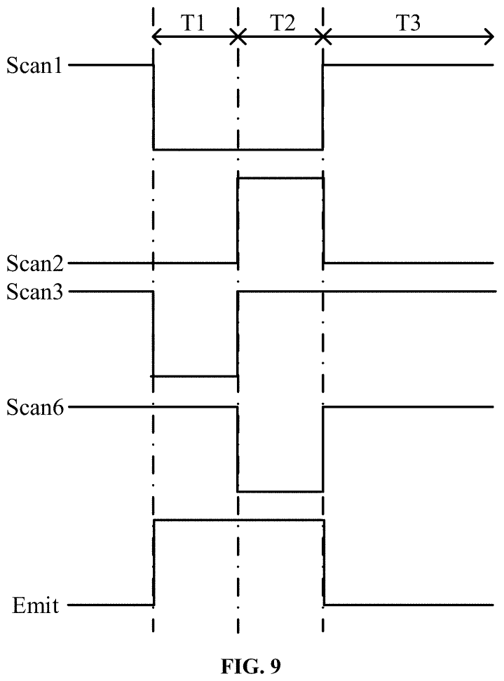

In an embodiment, the case where the channel type of each transistor in FIG. 8 is P-type is used as an example. FIG. 9 is a driving timing diagram of the pixel circuit corresponding to FIG. 8. In conjunction with FIGS. 8 and 9, the specific operation principle of the pixel circuit 100 is described below.

In the reset stage T1, the first scanning signal Scan1 of the first scanning terminal S1 controls the first transistor M1 to be turned on, the second scanning signal Scan2 of the second scanning terminal S2 controls the second transistor M2 to be turned on, the third scanning signal Scan3 of the third scanning terminal S3 controls the third transistor to be turned on, the sixth scanning signal Scan6 of the sixth scanning terminal S6 controls the data write transistor M6 and the threshold compensation transistor M7 to be turned off, and the light emission control signal Emit of the light emission control terminal Em controls the first light emission control transistor M4 and the second light emission control transistor M5 to be turned off. In this case, the reset signal Vref of the reset signal terminal REF is transmitted to the first node N1 through the turned-on first transistor M1 to reset the first node N1; the reset signal Vref of the reset signal terminal REF is stored in the storage capacitor Cst and coupled to the second node N2 through the storage capacitor Cst to reset the second node N2, that is, to reset the gate of the drive transistor T; the reset signal Vref of the reset signal terminal REF is transmitted from the first node N1 to the third node N3 through the turned-on second transistor M2 to reset the first electrode of the drive transistor T. In this manner, the gate and the first electrode of the drive transistor T are both reset by the reset signal Vref so that the drive transistor T is restored from the bias state in the previous driving cycle to the non-bias state to prepare for the writing of the data signal. At the end of the reset stage T1, the potentials of the first node N1, the second node N2, and the third node N3 are all voltages of the reset signal Vref

In the data write stage T2, the first scanning signal Scan1 of the first scanning terminal S1 controls the first transistor M1 to remain on, the second scanning signal Scan2 of the second scanning terminal S2 controls the second transistor M2 to be turned off, the third scanning signal Scan3 of the third scanning terminal S3 controls the third transistor M3 to be turned on, the sixth scanning signal Scan6 of the sixth scanning terminal S6 controls the data write transistor M6 and the threshold compensation transistor M7 to be turned on, and the light emission control signal Emit of the light emission control terminal Em controls the first light emission control transistor M4 and the second light emission control transistor M5 to remain off. The data signal Vdata of the data signal terminal DATA is written to the second node N2 sequentially through the turned-on data write transistor M6, the drive transistor T, and the threshold compensation transistor M7, compensates the threshold voltage Vth of the drive transistor T to the second node N2, and is stored in the storage capacitor Cst. In this case, the potential VN2 of the second node N2 is equal to Vdata+Vth; in addition, the reset signal Vref of the reset signal terminal REF is transmitted to the first node N1 through the turned-on first transistor M1 so that the potential of the first node N1 is remained as the voltage of the reset signal Vref, that is, the potential VN1 of the first node N1 is equal to Vref.

In the light emission stage T3, the first scanning signal Scan1 of the first scanning terminal S1 controls the first transistor M1 to be turned off, the second scanning signal Scan2 of the second scanning terminal S2 controls the second transistor M2 to be turned on, the third scanning signal Scan3 of the third scanning terminal S3 controls the third transistor M3 to be turned off, the sixth scanning signal Scan6 of the sixth scanning terminal S6 controls the data write transistor M6 and the threshold compensation transistor M7 to be turned off, and the light emission control signal Emit of the light emission control terminal Em is an enabling level that controls the first light emission control transistor M4 and the second light emission control transistor M5 to be turned on. The power signal Vdd of the first power supply terminal PVDD is transmitted to the first node N1 through the first light emission control transistor M4 and the second transistor M2 that are sequentially turned on so that the potential of the first node N1 varies from Vref to Vdd, the potential of the first node N1 rises by ΔV=Vdd−Vref and coupled to the second node N2 through the storage capacitor Cst, and thus the potential of the second node N2 also rises by ΔV. In this case, the potential of the second node N2 becomes Vdata+Vth+Vdd−Vref and the potential of the second node N2 is raised; at the same time, the first light emission control transistor M4 and the second light emission control transistor M5 enable a current path to be formed between the first power supply terminal PVDD and the second power supply terminal PVEE so that the drive current Id generated by the drive transistor T according to the raised potential of the second node N2 is provided to the light-emitting element 40 to drive the light-emitting element 40 to emit light.

It is to be understood that FIG. 8 only exemplarily shows that the channel type of each transistor is P-type, and in the embodiments of the present disclosure, the channel type of each transistor in the pixel circuit is not specifically limited.

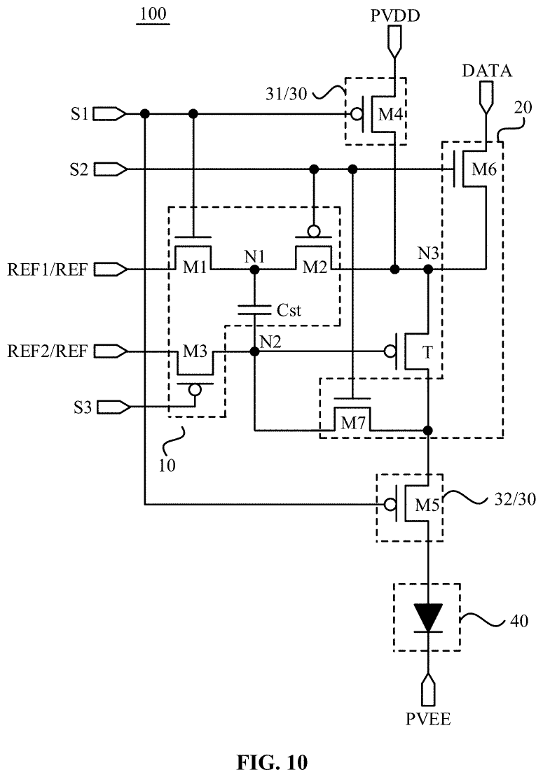

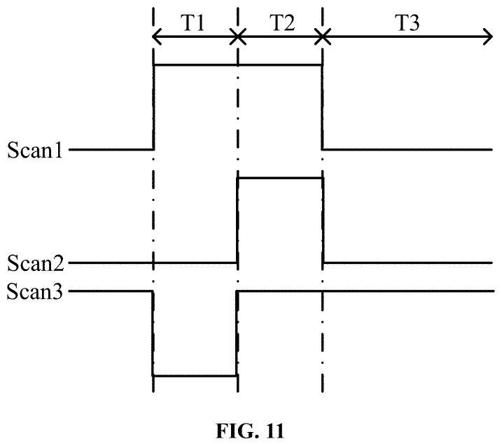

In an embodiment, FIG. 10 is a specific circuit diagram of another pixel circuit according to an embodiment of the present disclosure, and FIG. 11 is a driving timing diagram of the pixel circuit corresponding to FIG. 10. In conjunction with FIGS. 10 and 11, the channel types of the first transistor M1, the data write transistor M6, and the threshold compensation transistor M7 are all N-type, and the channel types of the second transistor M2, the first light emission control transistor M4, and the second light emission control transistor M5 are all P-type. In this case, the channel type of the first transistor M1 is different from the channel type of the first light emission control transistor M4, and the channel type of the second transistor M2 is different from the channel type of the data write transistor M3 so that the first scanning terminal S1 can be reused as the light emission control terminal, and the second scanning terminal S2 can be reused as the sixth scanning terminal. In the reset stage T1, the first scanning signal Scan1 of the first scanning terminal S1 controls the first transistor M1 to be turned on and controls the first light emission control transistor M4 to be turned off, the second scanning signal Scan2 of the second scanning terminal S2 controls the second transistor M2 to be turned on and controls the data write transistor M6 to be turned off, and the third scanning signal Scan3 of the third scanning terminal S3 controls the third transistor M3 to be turned on. In the data write stage T2, the first scanning signal Scan1 of the first scanning terminal S1 controls the first transistor M1 to be turned on and controls the first light emission control transistor M4 to be turned off, the second scanning signal Scan2 of the second scanning terminal S2 controls the second transistor M2 to be turned off and control the data write transistor M6 to be turned on, and the third scanning signal Scan3 of the third scanning terminal S3 controls the third transistor M3 to be turned off. In the light emission stage T3, the first scanning signal Scan1 of the first scanning terminal S1 controls the first transistor M1 to be turned off and controls the first light emission control transistor M4 to be turned on, the second scanning signal Scan2 of the second scanning terminal S2 controls the second transistor M2 to be turned on and controls the data write transistor M6 to be turned off, and the third scanning signal Scan3 of the third scanning terminal S3 controls the third transistor M3 to be turned off.

In this manner, the first scanning terminal S1 is reused as the light emission control terminal and the second scanning terminal S2 is reused as the sixth scanning terminal so that the number of the signal terminals in the pixel circuit 100 can be reduced, the structure of the pixel circuit 100 can be simplified, and the number of the signals provided to the pixel circuit 100 can be reduced, which is conductive to simplifying the structure of the display panel and reducing the cost of the display panel.

It is to be noted that FIG. 10 is only an exemplary drawing of the embodiments of the present disclosure. FIG. 10 only exemplarily shows that the channel type of the first transistor M1 is N-type and the channel type of the first light emission control transistor M4 is P-type; and in the embodiments of the present disclosure, the channel type of the first transistor M1 may also be P-type, and at this time, the channel type of the first light emission control transistor M4 is N-type. Similarly, in the embodiments of the present disclosure, the channel type of the second transistor M2 may also be N-type, and at this time, the channel type of the data write transistor M6 is N-type.

In an embodiment, with continued reference to FIG. 10, the reset signal terminal REF includes a first reset signal terminal REF1 and a second reset signal terminal REF2, and the reset signal terminal REF electrically connected to the first electrode of the first transistor M1 is the first reset signal terminal REF1; and the reset signal terminal REF electrically connected to the first electrode of the third transistor M3 is the second reset signal terminal REF2. In this case, a first reset signal Vref1 of the first reset signal terminal REF1 and a second reset signal Vref2 of the second reset signal terminal REF2 may be the same or different to satisfy different reset requirements.

In an embodiment, a voltage of the first reset signal Vref1 of the first reset signal terminal REF1 is greater than a voltage of the second reset signal Vref2 of the second reset signal terminal REF2.

At the end of the reset stage, the potential VN1 of the first node N1 is the first reset signal Vref1, and the potential VN2 of the second node N2 is the second reset signal Vref2; at the end of the data write stage, the potential VN1 of the first node N1 is remained as the first reset signal Vref1, and the potential VN2 of the second node N2 is Vdata+Vth; and in the light emission stage, the potential of the first node N1 rises by Vdd−Vref1, and the potential of the second node N2 rises accordingly by Vdd−Vref1. The voltage of the first reset signal Vref1 is relatively large. Therefore, Vdd−Vref1 is a relatively small voltage so that the case where the excessive small current provided by the drive transistor T to the light-emitting element 40 due to the excessive large voltage of the second node N2 in the light emission stage affects the luminous brightness of the light-emitting element 40 can be avoided, to improve the light-emitting effect of the light-emitting element 40.

In an embodiment, with continued reference to FIG. 10, when the drive transistor is a P-type transistor, the threshold voltage Vth of the drive transistor is negative; in addition, only when the potential difference between the gate and the first electrode of the drive transistor T is less than the threshold voltage of the drive transistor T, the drive transistor T can remain on. In this case, the voltage difference between the voltage of the second reset signal Vref2 and the voltage of the first reset signal Vref1 ranges within 0<Vref2−Vref1≤|Vth|. In this manner, at the end of the reset stage, the potential difference between the gate and the first electrode of the drive transistor T can satisfy the conduction condition of the drive transistor T, to ensure that the data signal of the data signal terminal can be smoothly written to the second node N2 in the data write stage.

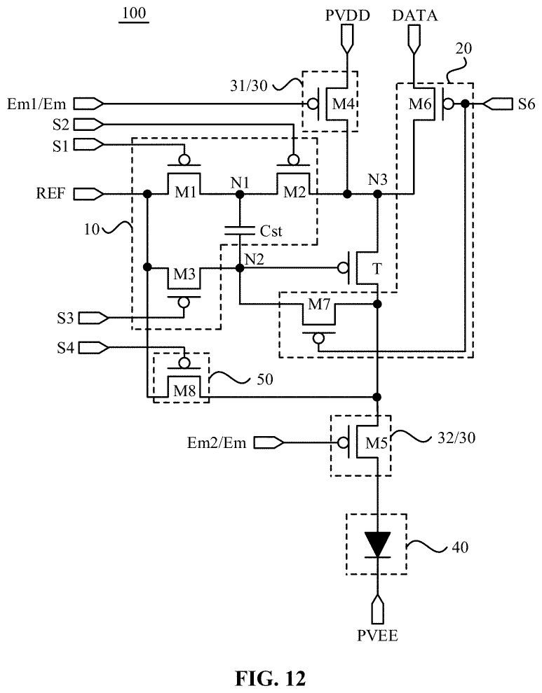

Based on the preceding embodiments, in an embodiment, FIG. 12 is a structure diagram of another pixel circuit according to an embodiment of the present disclosure. As shown in FIG. 12, the pixel circuit 100 further includes an initialization device 50, where a first terminal of the initialization device 50 is electrically connected to the reset signal terminal REF, a second terminal of the initialization device 50 is electrically connected to the second electrode of the drive transistor T, and the initialization device 50 is configured to write the reset signal Vref of the reset signal terminal REF to the second electrode of the drive transistor T.

In this manner, in the reset stage, the node control device 10 separately reset the gate and the first electrode of the drive transistor T, and the initialization device 50 resets the second electrode of the drive transistor T so that in the reset stage of each driving cycling, the gate, the first electrode, and the second electrode of the drive transistor T can be in a fixed state to prevent the hysteresis effect of the drive transistor T, which is conductive to the writing of the data signal in the data write stage, improving the accuracy of the data signal written to the gate of the drive transistor T, improving the accuracy of the luminous brightness of the light-emitting element 40, and thus improving the display effect of the display panel.

In an embodiment, with continued reference to FIG. 12, the pixel circuit 100 further includes a fourth scanning terminal S4; the initialization device 50 includes an initialization transistor M8, where a gate of the initialization transistor M8 is electrically connected to the fourth scanning terminal S4, a first electrode of the initialization transistor M8 is electrically connected to the reset signal terminal REF, and a second electrode of the initialization transistor M8 is electrically connected to the second electrode of the drive transistor T. In this manner, the initialization transistor M8 may be turned on or off under the control of a fourth scanning signal of the fourth scanning terminal S4, and when the fourth scanning signal of the fourth scanning terminal S4 controls the initialization transistor M8 to be turned on, the initialization transistor M8 can transmit the reset signal of the reset signal terminal REF to the second electrode of the drive transistor T to reset the second electrode of the drive transistor T.

Correspondingly, when the first light emission control unit 31 includes the first light emission control transistor M4 and the second light emission control unit 32 includes the second light emission control transistor M5, the light emission control terminal EM may include a first light emission control terminal Em1 and a second light emission control terminal Em2; the light emission control terminal electrically connected to the first light emission control transistor M4 is the first light emission control terminal Em1, and the light emission control terminal electrically connected to the second light emission control transistor M5 is the second light emission control terminal Em2. In this manner, the first light emission control transistor M4 can be turned on under the control of a first light emission control signal of the first light emission control terminal Em1, and the second light emission control transistor M5 can be turned on under the control of a second light emission control signal of the second light emission control terminal Em2; in this case, the first light emission control transistor M4 and the second light emission control transistor M5 can be turned on and/or turned off at different times.

In an embodiment, with continued reference to FIG. 12, the first light emission control terminal Em1 controls the first light emission control transistor M4 to be turned on in the light emission stage; the second light emission control terminal Em2 controls the second light emission control transistor M5 to be turned on in the reset stage and the light emission stage.

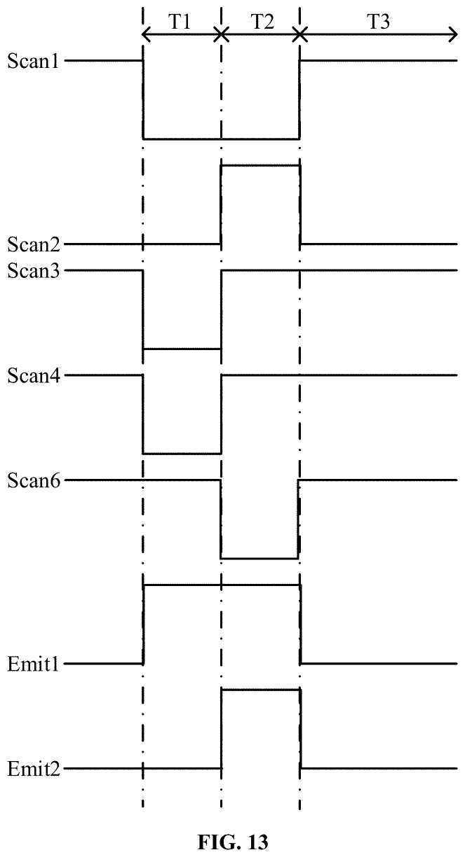

In an embodiment, the case where each transistor in the pixel circuit 100 is a P-type transistor is used as an example. In an embodiment, FIG. 13 is a driving timing diagram of the pixel circuit corresponding to FIG. 12. In conjunction with FIGS. 12 and 13, in the reset stage T1 of the pixel circuit 100, the first scanning signal Scan1 of the first scanning terminal S1 controls the first transistor M1 to be turned on, the second scanning signal Scan2 of the second scanning terminal S2 controls the second transistor M2 to be turned on, the third scanning signal Scan3 of the third scanning terminal S3 controls the third transistor M3 to be turned on, a fourth scanning signal Scan4 of the fourth scanning terminal controls the initialization transistor M8 to be turned on, and a second light emission control signal Emit2 of the second light emission control terminal Em2 controls the second light emission control transistor M5 to be in the on state and controls other transistors to be in the off state so that the reset signal Vref of the reset signal terminal REF is transmitted to the first node N1 through the turned-on first transistor M1 to reset the first node N1; at the same time, the reset signal Vref is stored in the storage capacitor Cst to reset the storage capacitor Cst; the reset signal Vref is transmitted from the first node N1 to the first electrode of the drive transistor T (the third node N3) through the turned-on second transistor M2 to reset the first electrode of the drive transistor T; the reset signal Vref of the reset signal terminal REF is transmitted to the second node N2 through the turned-on third transistor M3 to reset the gate of the drive transistor T; the reset signal Vref of the reset signal terminal REF is transmitted to the second electrode of the drive transistor T through the turned-on initialization transistor M8 to reset the second electrode of the drive transistor T; and the reset signal Vref is transmitted to the anode of the light-emitting element 40 through the turned-on second light emission control transistor M5 to reset the anode of the light-emitting element 40. In this manner, the gate, the first electrode, and the second electrode of the drive transistor T and the anode of the light-emitting element 40 can be reset at the same time in the reset stage T1 so that in the reset stage of each driving cycle, the drive transistor T remains in the non-bias state so that the hysteresis effect of the drive transistor T can be prevented from affecting the writing of the data signal, and the signal written to the anode of the light-emitting element 40 in the previous driving cycle can be cleared to prevent the signal in the previous driving cycle from affecting the luminous brightness of the light-emitting element 40 in the current driving cycle, improving the light-emitting effect of the light-emitting element 40.

It is to be understood that in the data write stage T2, the sixth scanning signal Scan6 of the sixth scanning terminal S6 controls the data write transistor M6 and the threshold compensation transistor M7 to be turned on, and the first scanning signal Scan1 of the first scanning terminal S1 controls the first transistor M1 to remain on and controls other transistors to be in the off state so that the operation principle in the data write stage T2 is similar to the operation principle in the data write stage T2 in the preceding embodiment and is not repeated herein.

Similarly, in the light emission stage T3, a first light emission control signal Emit1 of the first light emission control terminal Em1 controls the first light emission control transistor M4 to be in the on state, the second scanning signal Scan2 of the second scanning terminal S2 controls the second transistor M2 to be in the on state, and the second light emission control signal Emit2 of the second light emission control terminal Em2 controls the second light emission control transistor M5 to be in the on state and controls other transistors to be in the off state so that the operation principle in the light emission stage T3 is the same as the operation principle in the light emission stage T3 in the preceding embodiment and is not repeated herein.

It is to be noted that FIG. 12 is only an exemplary drawing of the embodiments of the present disclosure, and FIG. 12 only exemplarily shows the case where each transistor is a P-type transistor. In the embodiments of the present disclosure, each transistor may also be an N-type transistor; or part of the transistors are P-type transistors, and the other part of the transistors are N-type transistors.

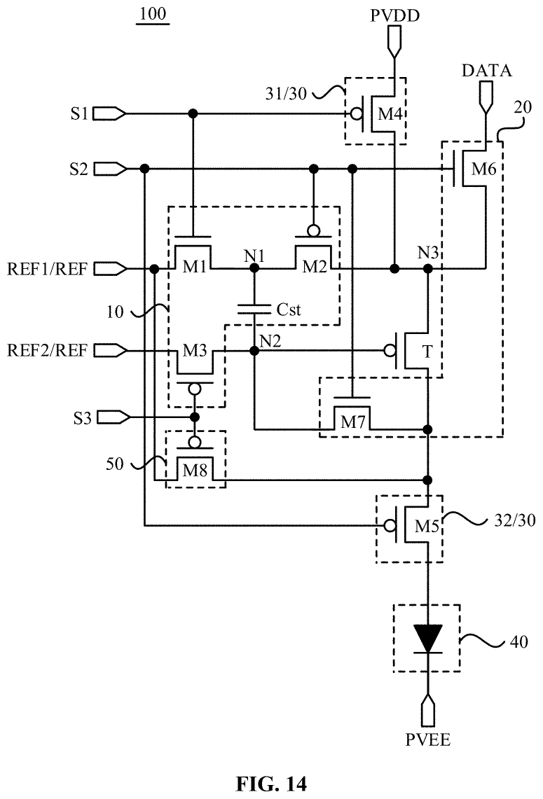

In an embodiment, FIG. 14 is a specific circuit diagram of another pixel circuit according to an embodiment of the present disclosure. As shown in FIG. 14, the first transistor M1, the data write transistor M6, and the threshold compensation transistor M7 are all P-type transistors, and the second transistor M2, the third transistor M3, the initialization transistor M8, the first light emission control transistor M4, and the second light emission control transistor M5 are all P-type transistors. In this case, the channel type of the initialization transistor M8 is the same as the channel type of the third transistor M3 so that the third scanning terminal S3 can be reused as the fourth scanning terminal; the channel type of the second transistor M2 is the same as the channel type of the second light emission control transistor M5 so that the second scanning terminal S2 can be reused as the second light emission control terminal; the channel type of the first transistor M1 is different from the channel type of the first light emission control transistor M4 so that the first scanning terminal S1 can be reused as the first light emission control terminal; the channel type of the second transistor M2 is different from the channel type of the data write transistor M6 so that the second scanning terminal S2 can be reused as the sixth scanning terminal; when the reset signal terminal REF includes the first reset signal terminal REF1 and the second reset signal terminal REF2, the reset signal terminal electrically connected to the initialization transistor M8 may be the first reset signal terminal REF1 so that in the reset stage, the potential of the first electrode of the drive transistor T is the same as the potential of the second electrode of the drive transistor T.

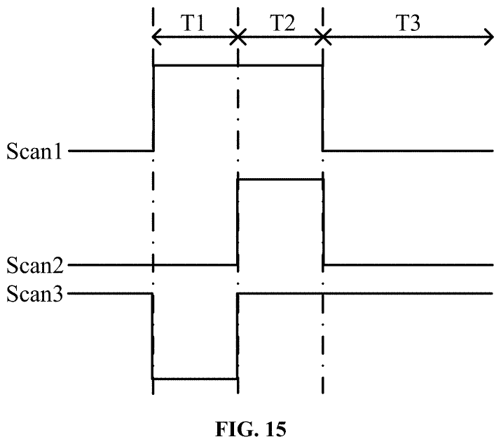

In an embodiment, FIG. 15 is a driving timing diagram of the pixel circuit corresponding to FIG. 14. In conjunction with FIGS. 14 and 15, in the reset stage T1, the first scanning signal Scan1 of the first scanning terminal S1 is a high-level signal, and the high-level first scanning signal Scan1 controls the first transistor M1 to be turned on and controls the first light emission control transistor M4 to be turned off; the second scanning signal Scan2 of the second scanning terminal S2 is a low-level signal, and the low-level second scanning signal Scan2 controls the second transistor M2 and the second light emission control transistor M5 to be turned on and controls the data write transistor M6 and the threshold compensation transistor M7 to be turned off; the third scanning signal Scan3 of the third scanning terminal S3 is a low-level signal, and the low-level third scanning signal Scan3 controls the third transistor M3 and the initialization transistor M8 to be in the on state at the same time.

In the data write stage T2, the first scanning signal Scan1 of the first scanning terminal S1 remains to be a high-level signal so that the first transistor M1 remains on, and the first light emission control transistor M4 is controlled to remain off; the second scanning signal Scan2 of the second scanning terminal S2 becomes a high-level signal, the high-level second scanning signal Scan2 controls the second transistor M2 and the second light emission control transistor M5 to be turned off and controls the data write transistor M6 and the threshold compensation transistor M7 to be turned on; the third scanning signal Scan3 of the third scanning terminal S3 becomes a high-level signal, and the high-level third scanning signal Scan3 controls the third transistor M3 and the initialization transistor M8 to be in the off state at the same time.

In the light emission stage T3, the first scanning signal Scan1 of the first scanning terminal S1 becomes a low-level signal, and the low-level first scanning signal Scan1 controls the first transistor M1 to be turned off and controls the first light emission control transistor M4 to be turned on; the second scanning signal Scan2 of the second scanning terminal S2 becomes a low-level signal, and the low-level second scanning signal Scan2 controls the second transistor M2 and the second light emission control transistor M5 to be turned on and controls the data write transistor M6 and the threshold compensation transistor M7 to be turned off; the third scanning signal Scan3 of the third scanning terminal S3 remains to be a high-level signal so that the third transistor M3 and the initialization transistor M8 remain in the off state.

It is to be understood that in the embodiments of the present disclosure, when the channel type of the initialization transistor M8 is the same as the channel type of the third transistor M3, the initialization transistor M8 and the third transistor M3 may be both N-type transistors; when the channel type of the second transistor M2 is the same as the channel type of the second light emission control transistor M5, the second transistor M2 and the second light emission control transistor M5 may be both N-type transistors; when the channel type of the first transistor M1 is different from the channel type of the first light emission control transistor M4, the first transistor M1 may be a P-type transistor and the first light emission control transistor M4 may be an N-type transistor; when the channel type of the second transistor M2 is different from the channel type of the data write transistor M6, the second transistor M2 may be an N-type transistor and the data write transistor M6 may be a P-type transistor.

Transistors of different channel types have different materials and/or doping types of active layers of the transistors so that the active layers of transistors of different channel types may be disposed in different film layers, respectively. A material of an active layer of the N-type transistor may include an oxide semiconductor material, and a material of an active layer of the P-type transistor may include a low-temperature polysilicon material.

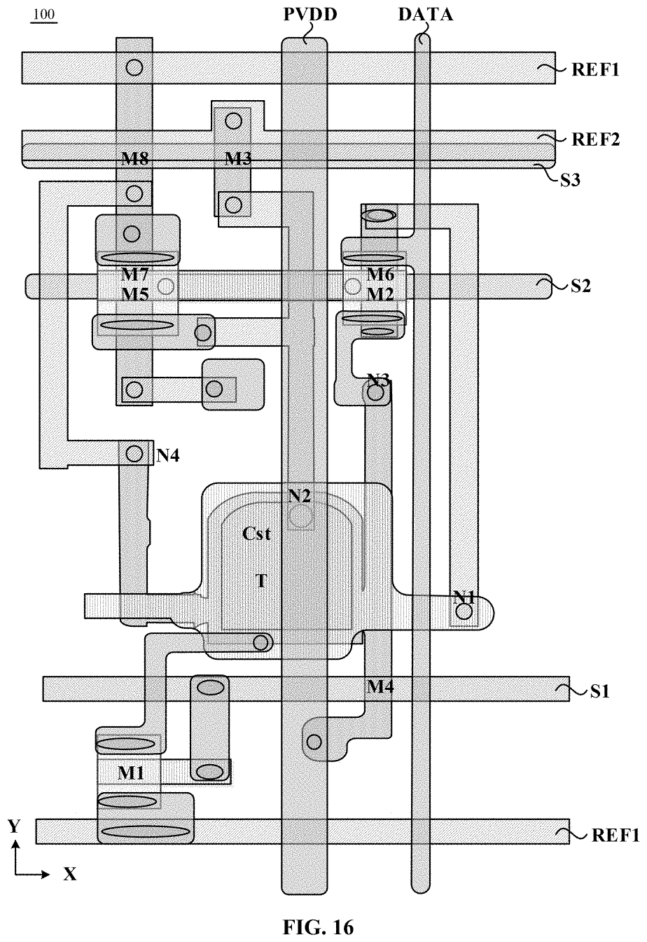

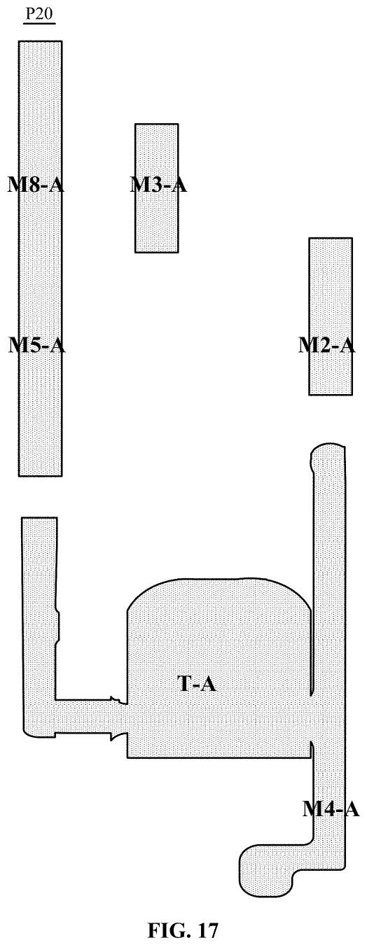

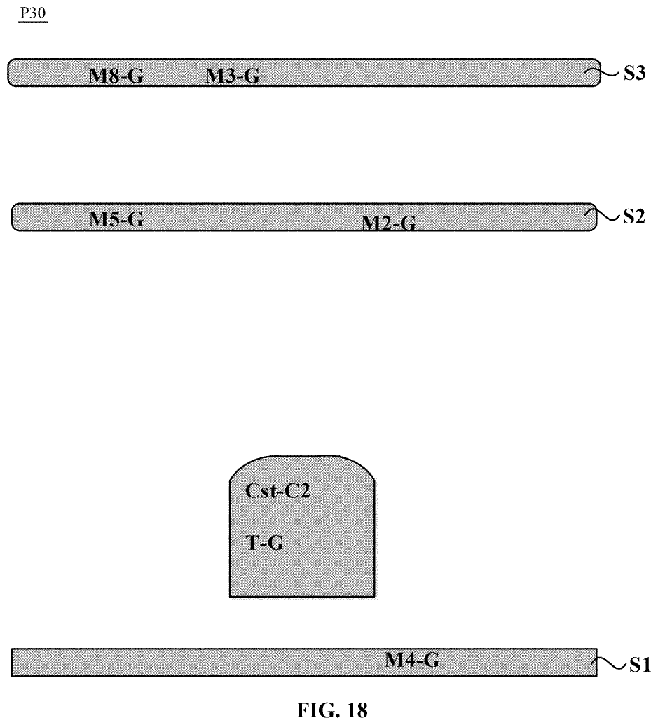

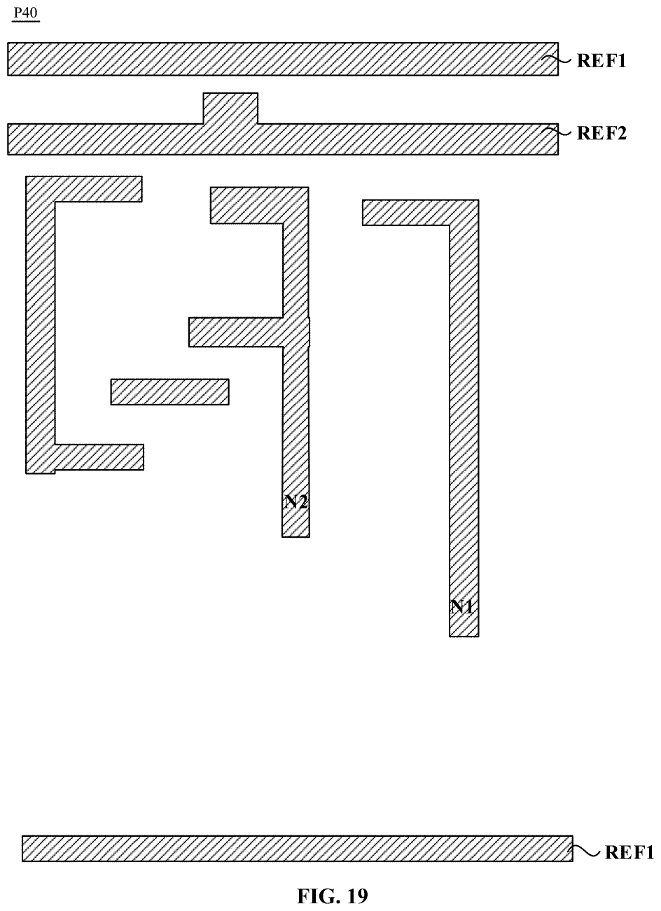

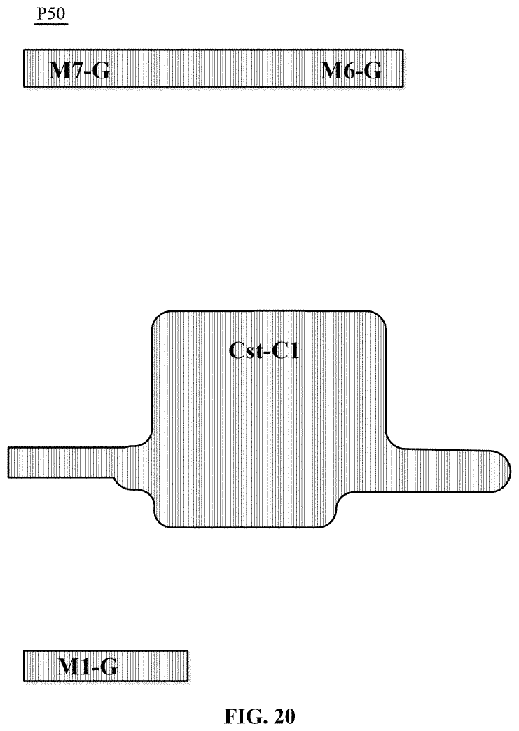

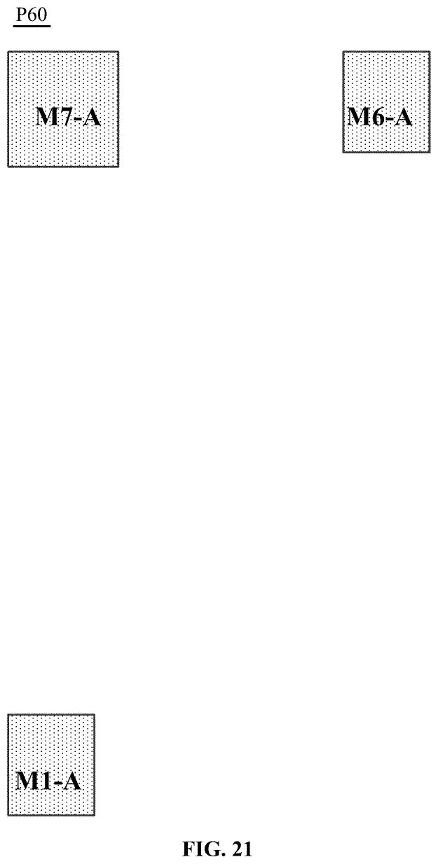

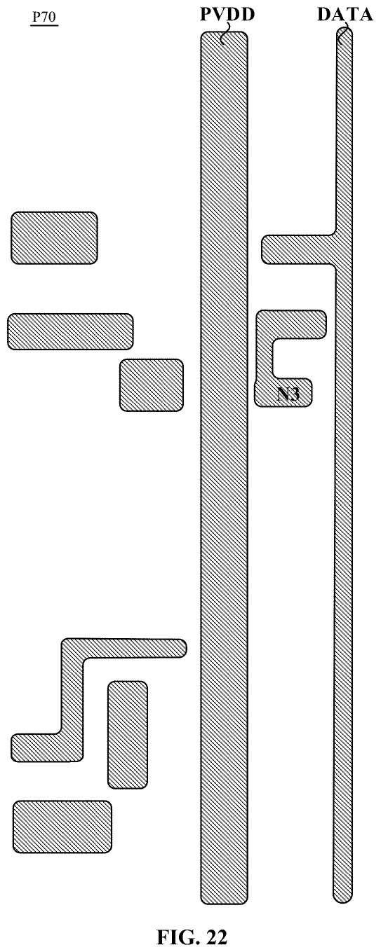

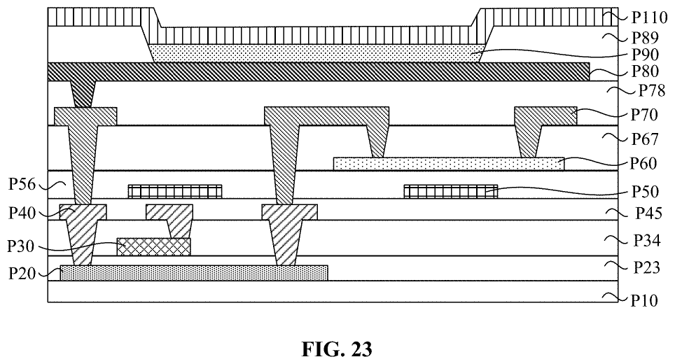

In an embodiment, the pixel circuit shown in FIG. 14 is used as an example. FIG. 16 is a top diagram of a pixel circuit according to an embodiment of the present disclosure. FIGS. 17 to 22 are structure diagrams of film layers of the pixel circuit corresponding to FIG. 16. FIG. 23 is a sectional diagram of a pixel circuit according to an embodiment of the present disclosure. In conjunction with FIG. 14, FIG. 16, and FIGS. 17 to 23, the pixel circuit 100 may include a base substrate P10 and functional film layers (P20, P30, P40, P50, P60, and P70) on a side of the base substrate P10 and insulating layers (P23, P34, P45, P56, and P67) located between the functional film layers. The functional film layers include a first semiconductor layer P20, a first metal layer P30, a second metal layer P40, a third metal layer P50, a second semiconductor layer P60, and a fourth metal layer P70; the insulating layers include an insulating layer P23 disposed between the first semiconductor layer P20 and the first metal layer P30, an insulating layer P34 disposed between the first metal layer P30 and the second metal layer P40, an insulating layer P45 disposed between the second metal layer P40 and the third metal layer P50, an insulating layer P56 disposed between the third metal layer P50 and the second semiconductor layer P60, and an insulating layer P67 disposed between the second semiconductor layer P60 and the fourth metal layer P70.

When a material of the first semiconductor layer P20 includes a low-temperature polysilicon material and a material of the second semiconductor layer includes an oxide semiconductor material such as indium zinc oxide, indium gallium zinc oxide, indium tin oxide, or indium gallium tin oxide, the first semiconductor layer P20 may include the active layer of the P-type transistor in the pixel circuit 100 and the second semiconductor layer P60 includes the active layer of the N-type transistor in the pixel circuit 100. For example, the first semiconductor layer P20 includes an active layer M2-A of the second transistor M2, an active layer M3-A of the third transistor M3, an active layer M8-A of the initialization transistor M8, an active layer M4-A of the first light emission control transistor M4, an active layer M5-A of the second light emission control transistor M5, and an active layer T-A of the drive transistor T; the second semiconductor layer P60 includes an active layer M1-A of the first transistor M1, an active layer M6-A of the data write transistor M6, and an active layer M7-A of the threshold compensation transistor M7. Correspondingly, the first metal layer P30 includes a gate M2-G of the second transistor M2, a gate M3-G of the third transistor M3, a gate M8-G of the initialization transistor M8, a gate M4-G of the first light emission control transistor M4, a gate M5-G of the second light emission control transistor M5, a gate T-G of the drive transistor T, the first scanning terminal S1, the second scanning terminal S2, and a second electrode plate Cst-C2 of the storage capacitor Cst, and the gate T-G of the drive transistor T is reused as the second electrode plate Cst-C2 of the storage capacitor Cst; the second metal layer P40 includes first electrodes and second electrodes of the second transistor M2, the third transistor M3, the initialization transistor M8, the first light emission control transistor M4, and the second light emission control transistor M5, as well as the first node N1, the second node N2, the first reset signal terminal REF1, and the second reset signal terminal REF2; the third metal layer P50 includes a first electrode plate Cst-C1 of the storage capacitor Cst, a gate M1-G of the first transistor M1, a gate M6-G of the data write transistor M6, and a gate M7-G of the threshold compensation transistor M7; the fourth metal layer P70 includes first electrodes and second electrodes of the first transistor M1, the data write transistor M6, and the threshold compensation transistor M7, as well as the third node N3, the first power supply terminal PVDD, and the data signal terminal DATA.

In addition, the pixel circuit 100 may further include a planarization layer P78 disposed on a side of the fourth metal layer P70 facing away from the base substrate P10, a pixel defining layer P89, as well as an anode P80, a light-emitting layer P90, and a cathode P110 of the light-emitting layer 40. The anode P80 of the light-emitting element 40 is electrically connected to the second electrode of the second light emission control transistor M5 through a via hole; other transistors disposed in different film layers may be electrically connected to each other through via holes, and the first transistor M1, the second transistor M2, and the third transistor M3 may be electrically connected to the storage capacitor Cst through the via holes.

In addition, in the embodiments of the present disclosure, the first electrode of each transistor may be a source and the second electrode of each transistor may be a drain; or the first electrode of each transistor may the drain and the second electrode of each transistor may be the source. A position where the active layer and the gate of each transistor overlap is a channel region of the transistor; in addition, the active layer further includes a source region and a drain region, where the source region of the transistor is electrically connected to the source of the transistor through the via hole, and the drain region of the transistor is electrically connected to the drain of the transistor through the via hole.

With continued reference to FIGS. 16 to 23, the active layer M6-A of the data write transistor M6 and the active layer M2-A of the second transistor M2 are disposed in different film layers, and the active layer M7-A of the threshold compensation transistor M7 and the active layer M5-A of the second light emission control transistor M5 are disposed in different film layers. Therefore, in a direction perpendicular to the base substrate P10, a channel region of the active layer M6-A of the data write transistor M6 may overlap with a channel region of the active layer M2-A of the second transistor M2, and a channel region of the active layer M7-A of the threshold compensation transistor M7 may overlap with a channel region of the active layer M5-A of the second light emission control transistor M5. The gate M6-G of the data write transistor M6 and the gate M7-G of the threshold compensation transistor M7 are both disposed in the third metal layer P50, and the gate M2-G of the second transistor M2 and the gate M5-G of the second light emission control transistor M5 are disposed in the first metal layer P30 so that when the gate M2-G of the second transistor M2, the gate M6-G of the data write transistor M6, the gate M7-G of the threshold compensation transistor M7, and the gate M5-G of the second light emission control transistor M5 are all electrically connected to the second scanning terminal S2, the gate M2-G of the second transistor M2 and the gate M5-G of the second light emission control transistor M5 can be arranged in an integral structure, the gate M6-G of the data write transistor M6 and the gate M7-G of the threshold compensation transistor M7 can be arranged in an integral structure, the gate M2-G of the second transistor M2 overlaps with the gate M6-G of the data write transistor M6, the gate M5-G of the second light emission control transistor M5 overlaps with the gate M7-G of the threshold compensation transistor M7, and the gate M2-G of the second transistor M2 and the gate M5-G of the second light emission control transistor M5 are electrically connected to the gate M6-G of the data write transistor M6 and the gate M7-G of the threshold compensation transistor M7 through via holes. The via hole electrically connected to the gate M6-G of the data write transistor M6 and the gate M2-G of the second transistor M2 may overlap with channel regions of the two transistors, and the via hole electrically connected to the gate of the third light emission control transistor M5 and the gate of the threshold compensation transistor M7 may overlap with channel regions of the two transistors; or the gate M2-G of the second transistor M2 and the gate M5-G of the second light emission control transistor M5 are an integral structure and the gate M6-G of the data write transistor M6 and the gate M7-G of the threshold compensation transistor M7 are an integral structure so that when only one via hole electrically connected to gates in different film layers is provided and the pixel circuit is applied to the display panel, the via hole electrically connected to the gates in different film layers may be disposed in a display region or a non-display region of the display panel, which is not specifically limited in the embodiments of the present disclosure.

This arrangement can help save the space occupied by the pixel circuit 100 so that the transistors in the pixel circuit 100 are arranged closely. Especially when the second transistor M2, the second light emission control transistor M5, the data write transistor M6, and the threshold compensation transistor M7 are disposed, only two positions used for disposing transistors need to be reserved in the X direction so that a dimension of the pixel circuit 100 in the first direction X can be reduced; each pixel circuit has one sub-pixel and three sub-pixels form one pixel unit, which is conductive to the layout design of each pixel unit.

It is to be noted that the relative positional relationship between film layers in the pixel circuit shown in FIGS. 16 to 23 is only an exemplary relative positional relationship in the embodiments of the present disclosure, and in the embodiments of the present disclosure, the relative positional relationship between the film layers is not specifically limited.

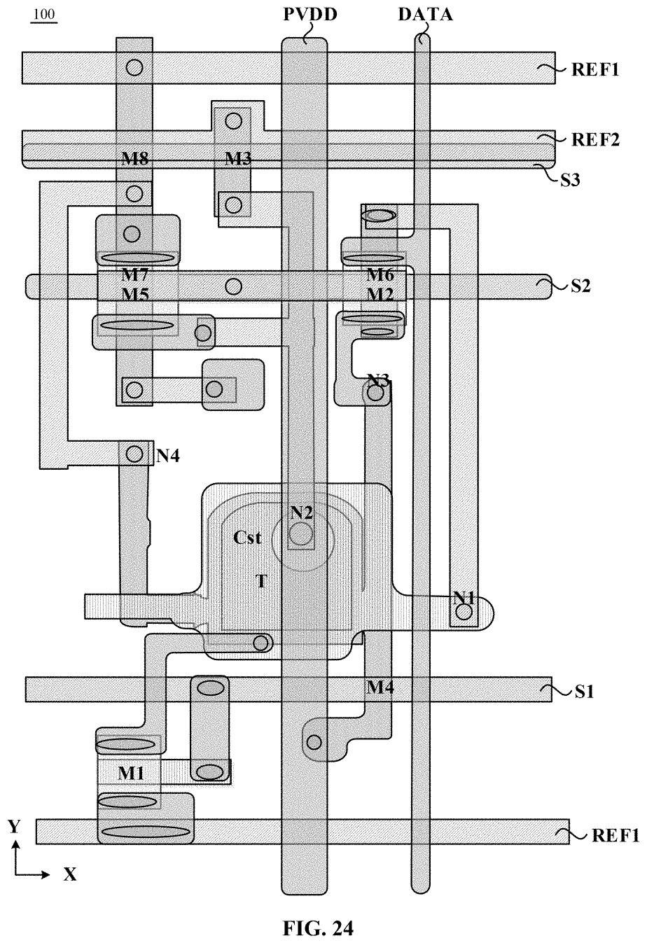

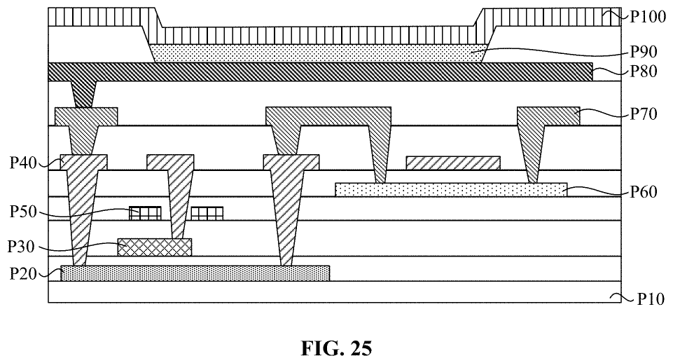

In an embodiment, FIG. 24 is a top diagram of another pixel circuit according to an embodiment of the present disclosure, and FIG. 25 is a sectional diagram of the pixel circuit corresponding to FIG. 24. For the same parts in FIGS. 24 and 25 and FIGS. 16 to 23, reference may be made to the preceding description of FIGS. 16 to 23, and only the differences between FIGS. 24 and 25 and FIGS. 16 to 23 are exemplified. In conjunction with FIGS. 24 and 25, the third metal layer P50 is disposed between the first metal layer P30 and the second semiconductor layer P60, the second metal layer P40 is disposed between the second semiconductor layer P60 and the fourth metal layer P70, and the second metal layer P40 is disposed on a side of the third metal layer P50 farther from the base substrate P10; in this case, the second electrode plate of the storage capacitor Cst is provided with an opening to expose the gate of the drive transistor T so that the second electrode of the third transistor M3 is electrically connected to the gate of the drive transistor T at the second node N2 through the via hole penetrating the opening in the second electrode plate of the storage capacitor Cst; when gates of P-type transistors (such as the second transistor M2 and the second light emission control transistor M5) are disposed in the first metal layer P30, gates of N-type transistors (such as the data write transistor M6 and the threshold compensation transistor M7) may be disposed in the second metal layer P40 so that the P-type transistors and the N-type transistors are both top gate structures.

In addition, when the second metal layer P40 is disposed on the side of the third metal layer P50 farther from the base substrate P10, the N-type transistors (such as the data write transistor M6 and the threshold compensation transistor M7) may be top-and-bottom double gate structures, where one gate may be disposed in the third metal layer P50 and the other gate may be disposed in the second metal layer P40. In the embodiments of the present disclosure, the arrangement of each transistor may be set according to requirements, which is not specifically limited in the embodiments of the present disclosure.

It is to be understood that both FIGS. 16 and 24 exemplarily show that structures of different film layers are electrically connected to each other through the via hole, and in the embodiments of the present disclosure, multiple via holes may be provided to make structures of different film layers electrically connected to each other, which is not specifically limited in the embodiments of the present disclosure.

In addition, FIGS. 16 and 24 are only exemplary drawings of the embodiments of the present disclosure, and in the top diagram of the pixel circuit in the embodiments of the present disclosure, other structures may also be provided. For ease of description, the relative positional relationship of the film layers shown in FIG. 23 is used as an example below to illustrate the top diagram of the pixel circuit in the embodiments of the present disclosure.

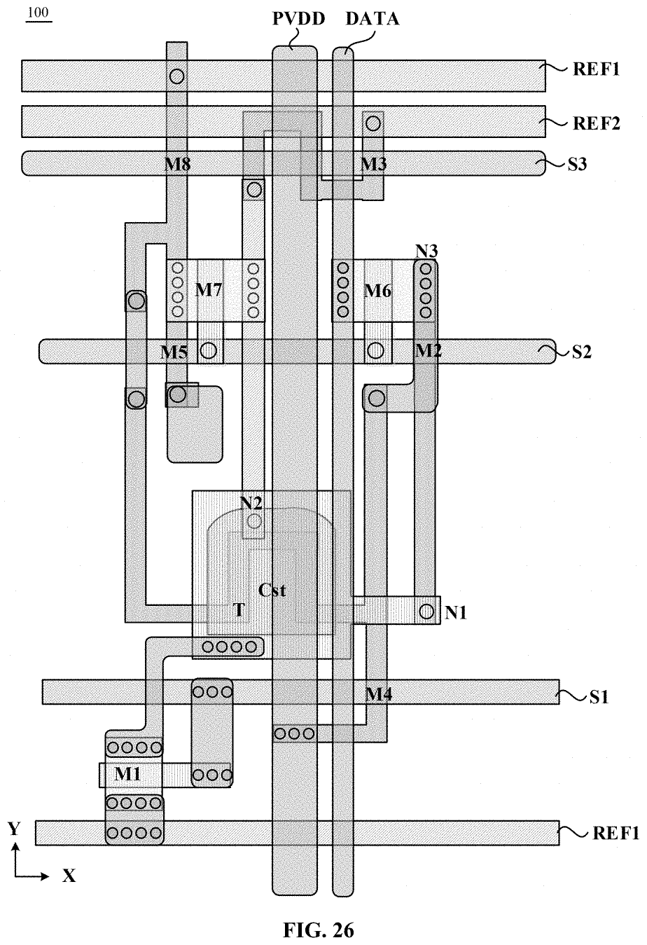

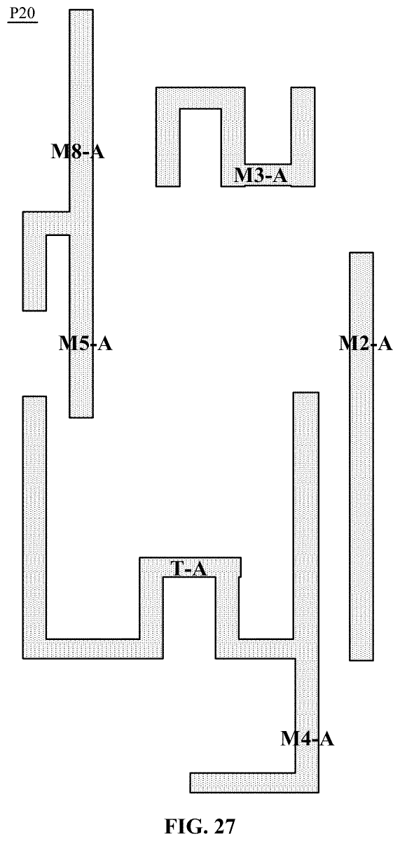

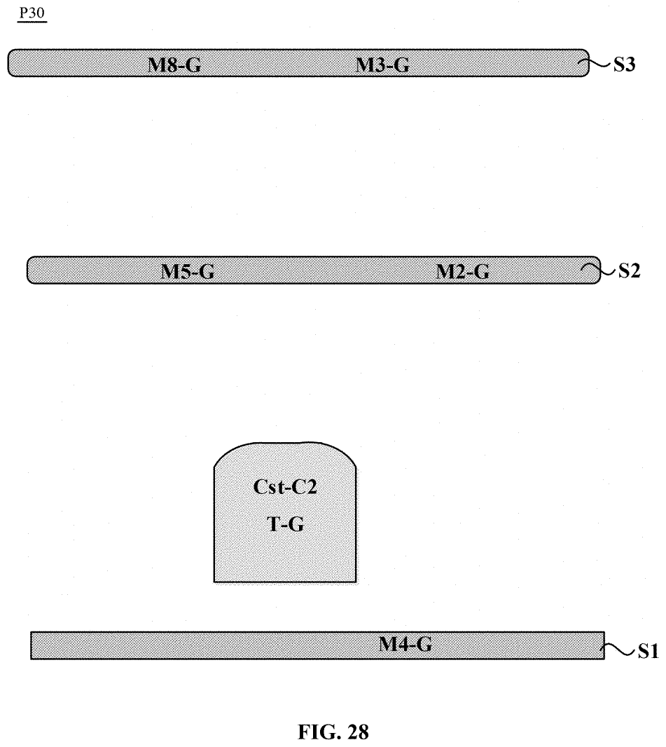

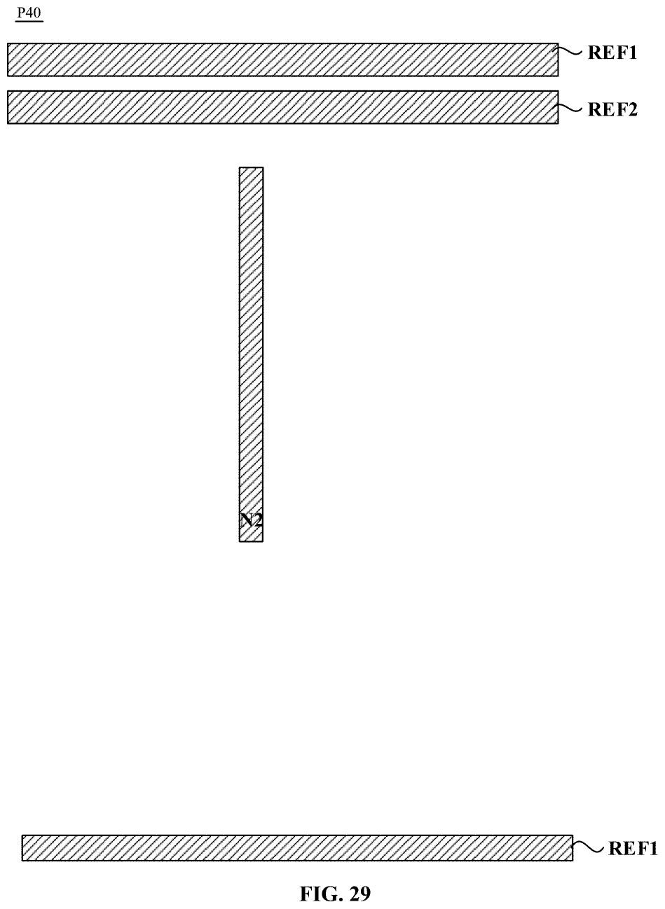

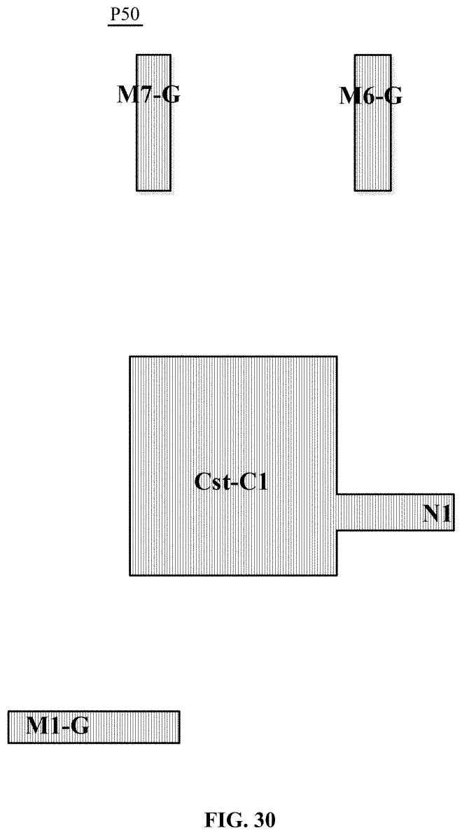

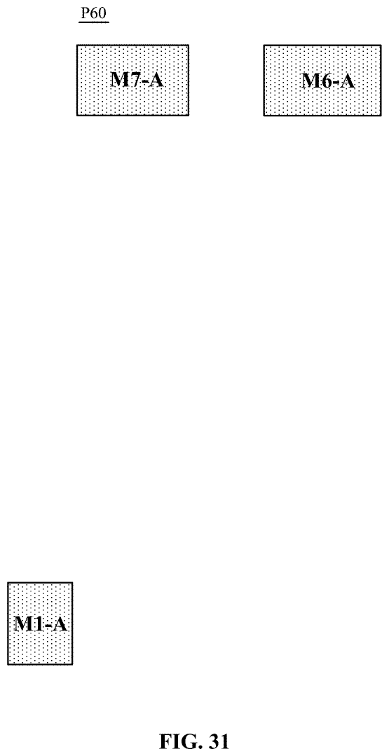

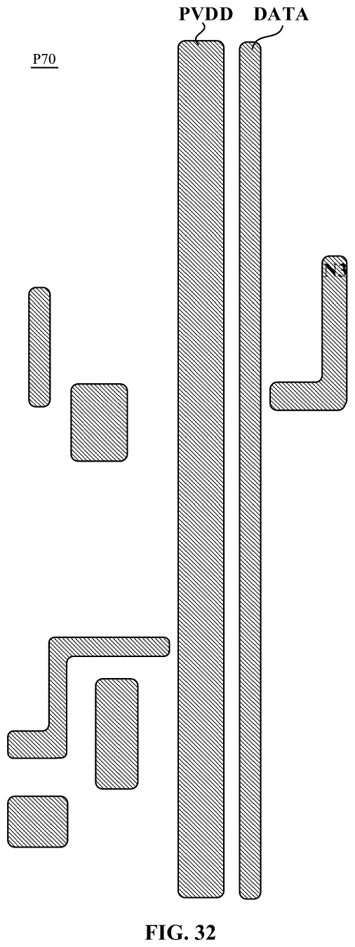

In an embodiment, FIG. 26 is a top diagram of another pixel circuit according to an embodiment of the present disclosure, and FIGS. 27 to 32 are structure diagrams of film layers of the pixel circuit corresponding to FIG. 26. For the same parts in FIGS. 26 to 32 and FIGS. 16 to 22, reference may be made to the preceding description of FIGS. 16 to 22, and only the differences between FIGS. 26 to 32 and FIGS. 16 to 22 are exemplified. In conjunction with FIGS. 26 to 32, the channel region of the active layer M7-A of the threshold compensation transistor M7 does not overlap with the channel region of the active layer M5-A of the second light emission control transistor M5, and the channel region of the active layer M2-A of the second transistor M2 does not overlap with the channel region of the active layer M6-A of the data write transistor M6, and the gate M2-G of the second transistor M2 and the gate M5-G of the second light emission control transistor M5 are an integral structure and electrically connected to the second scanning terminal S2; the gate M6-G of the data write transistor M6 is electrically connected to the gate M2-G of the second transistor M2 through the via hole, and the gate M7-G of the threshold compensation transistor M7 is electrically connected to the gate M5-G of the second light emission control transistor M5 through the via hole. In this manner, the gate M2-G of the second transistor M2, the gate M5-G of the second light emission control transistor M5, the gate M6-G of the data write transistor M6, and the gate M7-G of the threshold compensation transistor M7 are electrically connected to the same second scanning terminal S2, and there is no need to additionally set a scanning terminal of each transistor, which is conductive to saving the space occupied by the pixel circuit 100; especially the scanning terminals are sequentially arranged in a second direction Y, which is conductive to reducing a dimension of the pixel circuit 100 in the second direction Y; each pixel circuit has one sub-pixel and three sub-pixels form one pixel unit, which is conductive to the layout design in which the sub-pixels in each pixel unit borrow light emission from each other.

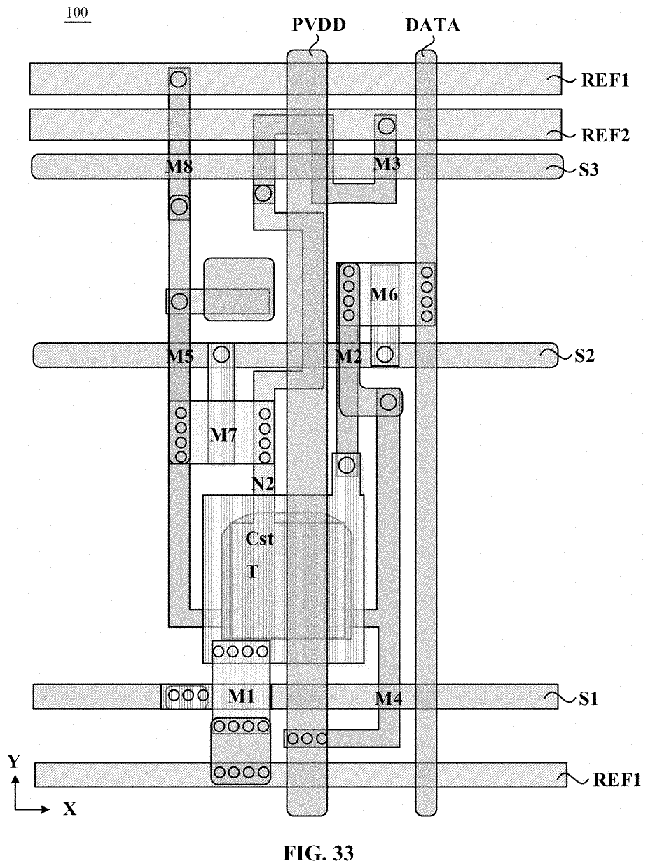

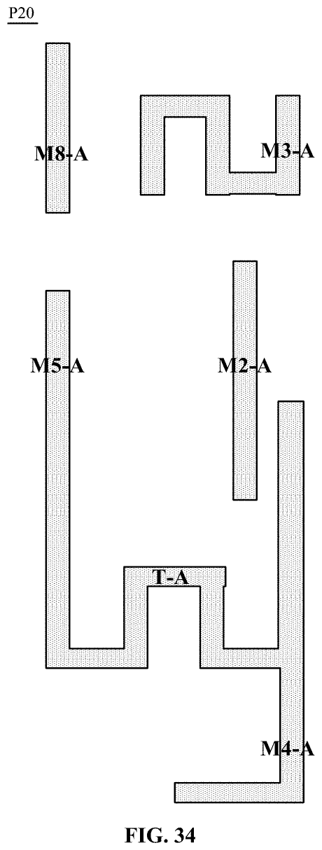

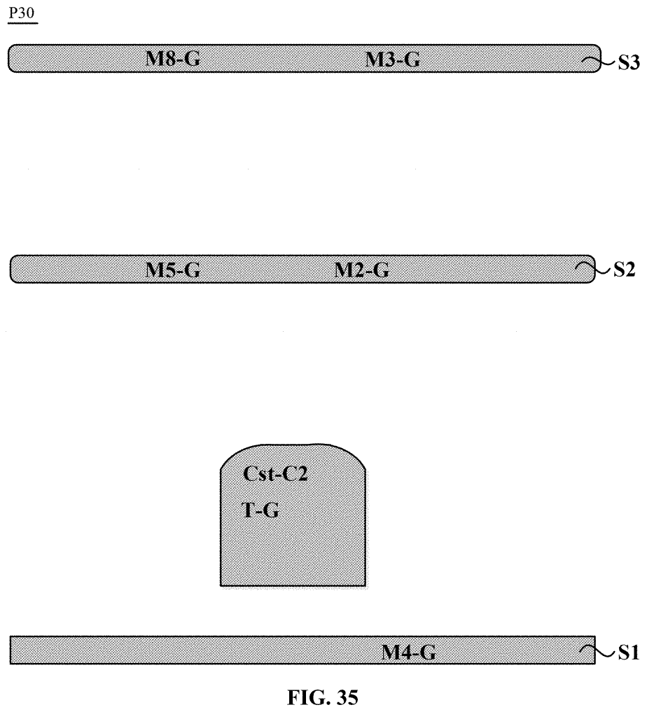

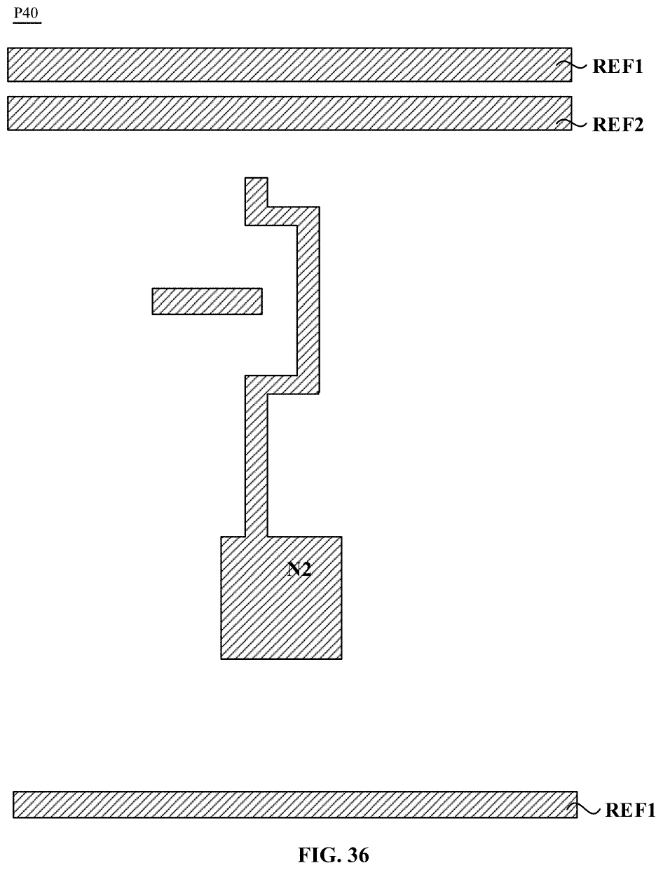

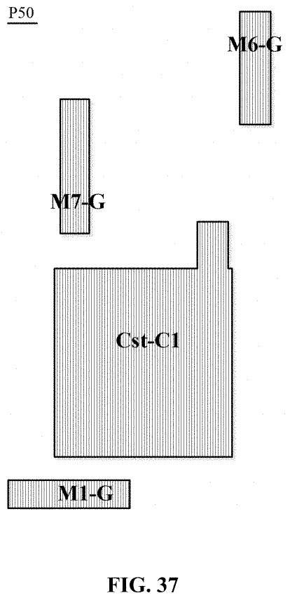

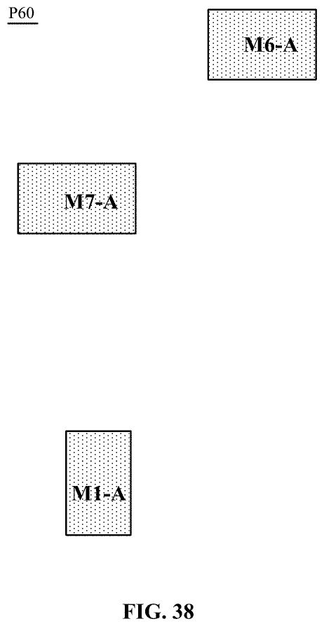

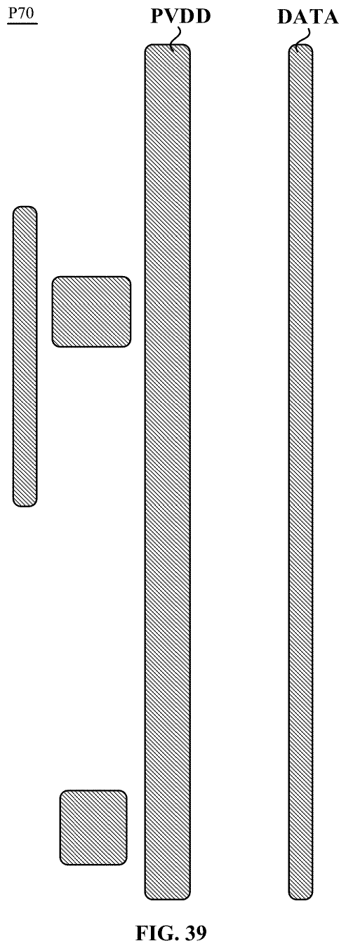

In an embodiment, FIG. 33 is a top diagram of another pixel circuit according to an embodiment of the present disclosure, and FIGS. 34 to 39 are structure diagrams of film layers of the pixel circuit corresponding to FIG. 33. For the same parts in FIGS. 33 to 39 and FIGS. 16 to 22, reference may be made to the preceding description of FIGS. 16 to 22, and only the differences between FIGS. 33 to 39 and FIGS. 16 to 22 are exemplified. In conjunction with FIGS. 34 to 39, the channel region of the active layer M7-A of the threshold compensation transistor M7 does not overlap with the channel region of the active layer M5-A of the second light emission control transistor M5, and the channel region of the active layer M2-A of the second transistor M2 does not overlap with the channel region of the active layer M6-A of the data write transistor M6; the gate M2-G of the second transistor M2 and the gate M5-G of the second light emission control transistor M5 are sequentially arranged in the first direction X and electrically connected, the threshold compensation transistor M7 and the data write transistor M6 are respectively disposed on opposite sides of the gate M2-G of the second transistor M2 and the gate M5-G of the second light emission control transistor M5, and the threshold compensation transistor M7 is disposed on a side of the data write transistor M6 facing towards to the gate T-G of the drive transistor T so that the second electrode of the threshold compensation transistor M7 may be electrically connected to the gate T-G of the drive transistor T through a relatively short signal line, and the path of threshold compensation can be shortened, which is conductive to reducing the resistance of the signal line electrically connecting the second electrode of the threshold compensation transistor M7 and the gate T-G of the drive transistor T, reducing signal loss, and speeding up a threshold compensation process.

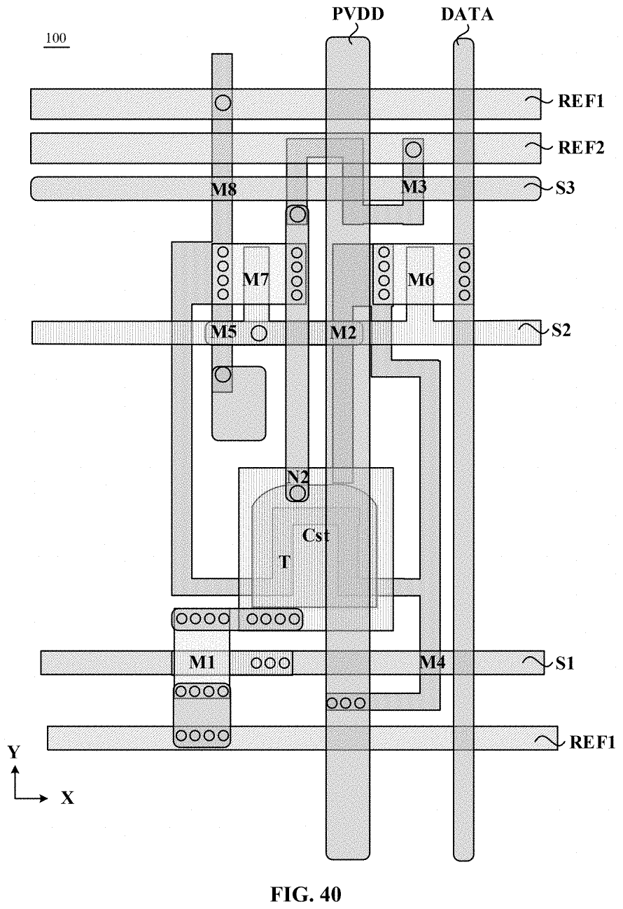

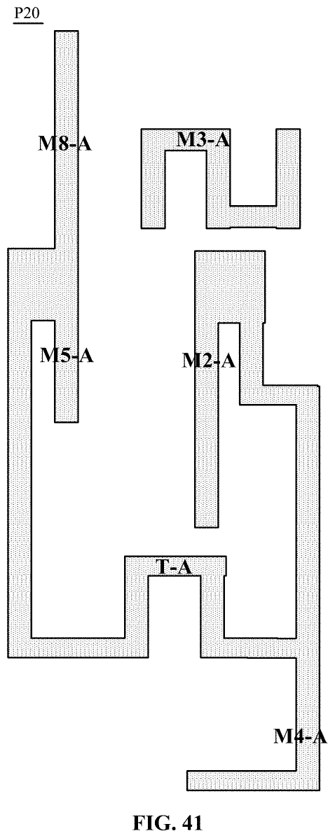

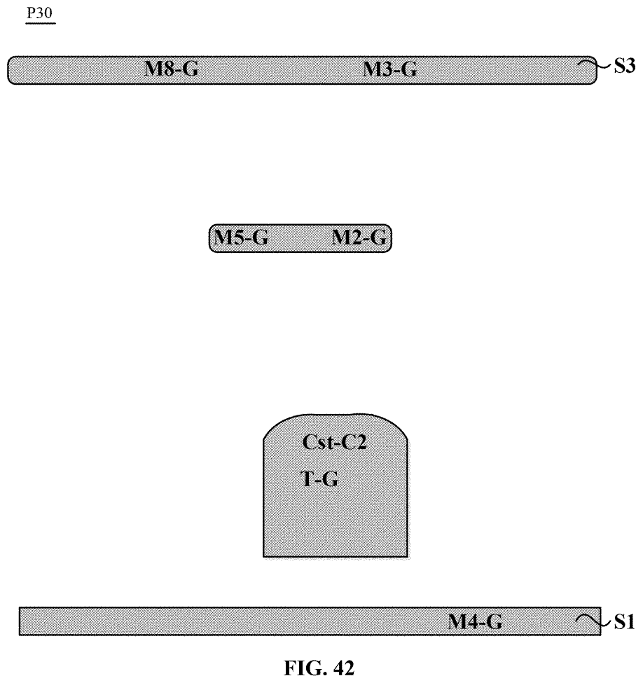

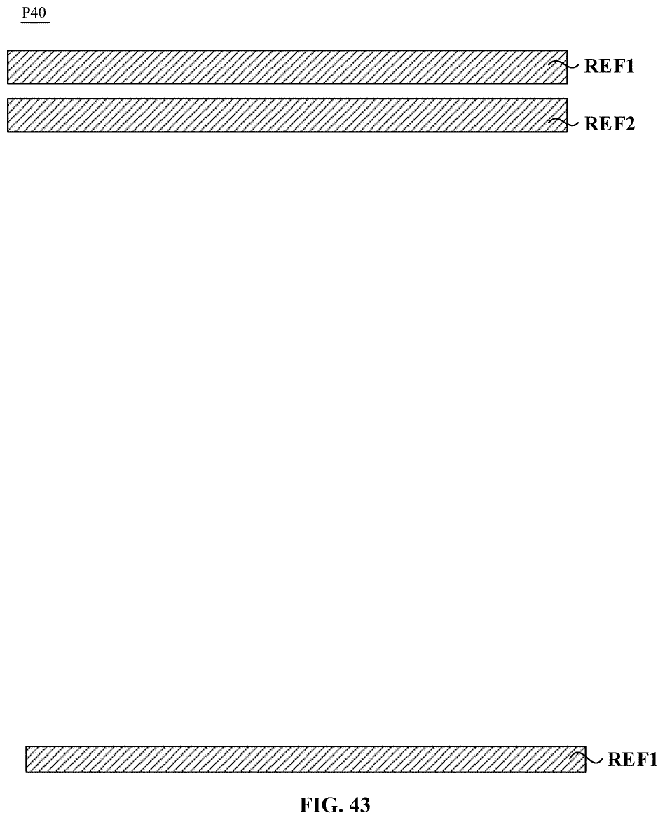

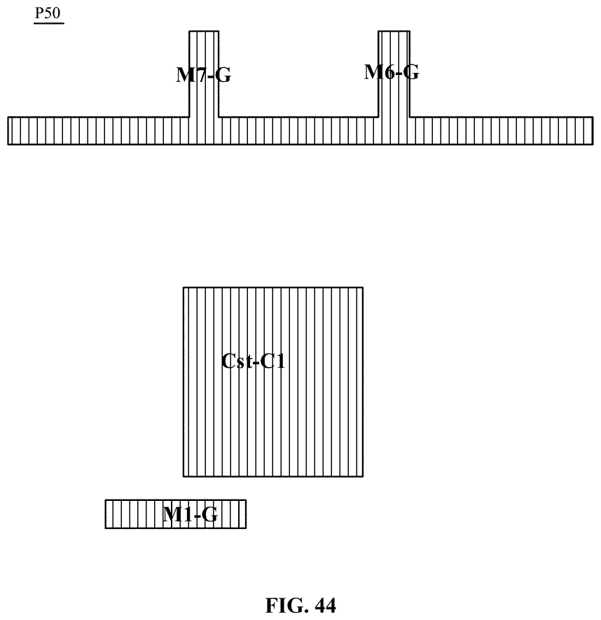

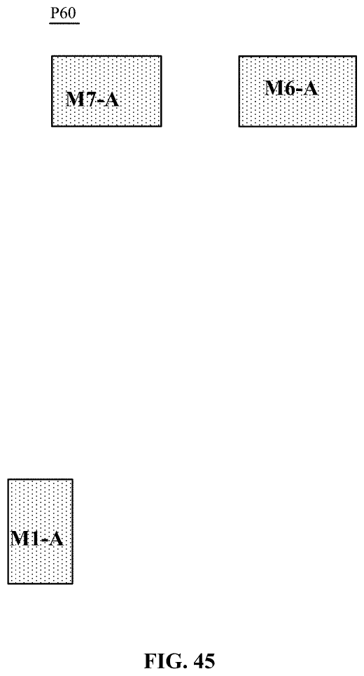

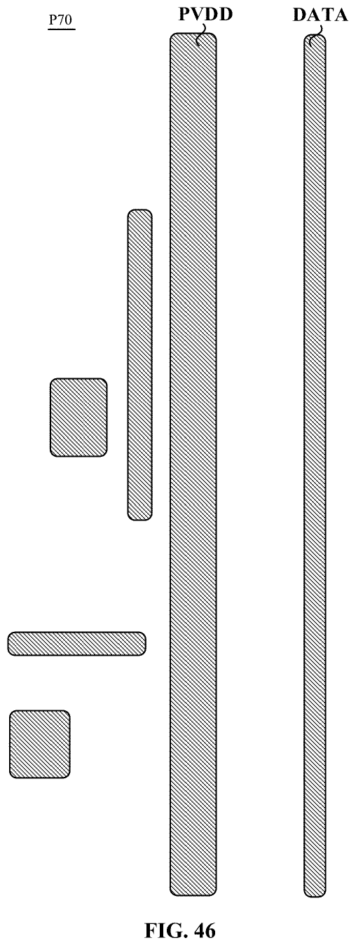

In an embodiment, FIG. 40 is a top diagram of another pixel circuit according to an embodiment of the present disclosure, and FIGS. 41 to 46 are structure diagrams of film layers of the pixel circuit corresponding to FIG. 40. For the same parts in FIGS. 40 to 46 and FIGS. 16 to 22, reference may be made to the preceding description of FIGS. 16 to 22, and only the differences between FIGS. 40 to 46 and FIGS. 16 to 22 are exemplified. In conjunction with FIGS. 40 to 46, the channel region of the active layer M7-A of the threshold compensation transistor M7 does not overlap with the channel region of the active layer M5-A of the second light emission control transistor M5, and the channel region of the active layer M6-A of the data write transistor M6 does not overlap with the channel region of the active layer M2-A of the second transistor M2; the gate M2-G of the second transistor M2 and the gate M5-G of the second light emission control transistor M5 are all disposed in the first metal layer P30, the gate M6-G of the data write transistor M6, the gate M7-G of the threshold compensation transistor M7, and the second scanning terminal S2 are disposed in the third metal layer P50; the gate M2-G of the second transistor M2 and the gate M5-G of the second light emission control transistor M5 are electrically connected to each other to form an integral structure and electrically connected to the second scanning terminal S2 through the via hole; the gate M6-G of the data write transistor M6 and the gate M7-G of the threshold compensation transistor M7 are integrated with the second scanning terminal S2; the data write transistor M6 and the threshold compensation transistor M7 are both disposed on the same side of the second scanning terminal S2; the active layer M2-A of the second transistor M2, the active layer M8-A of the initialization transistor M8, the active layer M4-A of the first light emission control transistor M4, the active layer M5-A of the second light emission control transistor M5, and the active layer T-A of the drive transistor T are a continuous entirety so that the first electrode and/or the second electrode of each P-type transistor can be electrically connected to each other without corresponding via holes, simplifying the process; in addition, the active layer of each P-type transistor is an integral structure so that static electricity generated in the manufacturing process of the pixel circuit can be evenly distributed in the active layer of each P-type transistor.

It is to be noted that the structure of the pixel circuit described above is only an exemplary structure of the embodiments of the present disclosure. In the embodiments of the present disclosure, the structure of the pixel circuit is not limited to this, and other structures may also be provided.

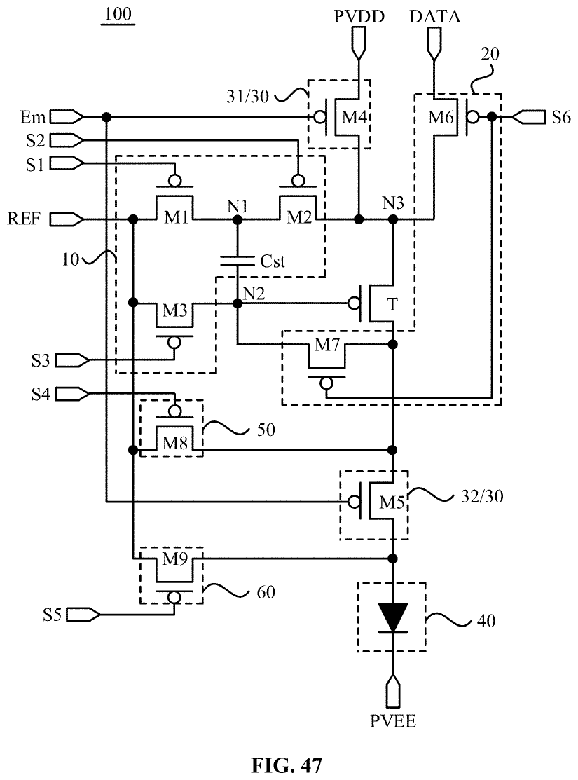

Based on the preceding embodiments, in an embodiment, FIG. 47 is a specific circuit diagram of another pixel circuit according to an embodiment of the present disclosure. As shown in FIG. 47, the pixel circuit 100 further includes an anode reset device 60, where a first terminal of the anode reset device 60 is electrically connected to the reset signal terminal REF, a second terminal of the anode reset device 60 is electrically connected to the anode of the light-emitting element 40, and the anode reset device 50 is configured to write the reset signal Vref of the reset signal terminal REF to the anode of the light-emitting element 40. In this manner, in the reset stage, the anode of the light-emitting element 40 is reset, to prevent the previous driving cycle from affecting the luminous brightness of the light-emitting element 40 in the current driving cycle.

In an embodiment, with continued reference to FIG. 47, the pixel circuit 100 may further include a fifth scanning terminal S5; the anode reset device 60 may include an anode reset transistor M9, where a gate of the anode reset transistor M9 is electrically connected to the fifth scanning terminal S5, a first electrode of the anode reset transistor M9 is electrically connected to the reset signal terminal REF, and a second electrode of the anode reset transistor M9 is electrically connected to the anode of the light-emitting element 40. In this manner, the anode reset transistor M9 can be turned on or off under the control of a fifth scanning signal Scan5 of the fifth scanning terminal S5, and when the fifth scanning signal Scan5 of the fifth scanning terminal S5 controls the anode reset transistor M9 to be turned on, the anode reset transistor M9 can transmit the reset signal Vref of the reset signal terminal REF to the anode of the light-emitting element 40 to reset the light-emitting element 40.

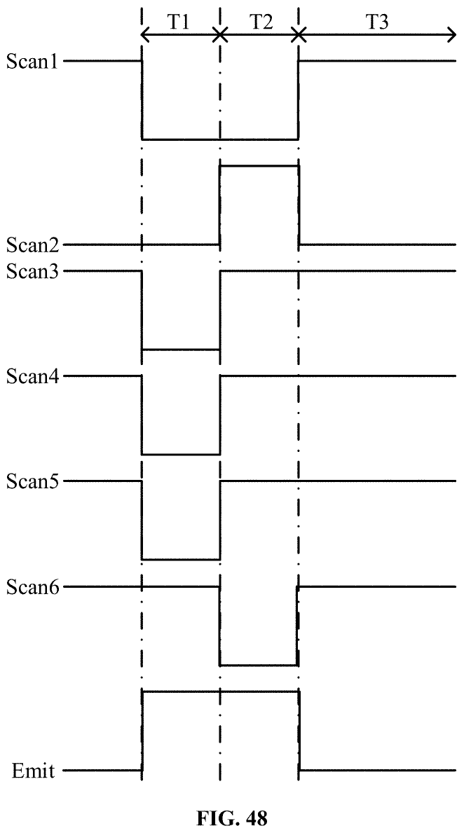

In an embodiment, the case where each transistor in FIG. 47 is a P-type transistor is used as an example, FIG. 48 is a driving timing diagram of the pixel circuit corresponding to FIG. 47. In conjunction with FIGS. 47 and 48, in the reset stage T1 of the pixel circuit 100, the first scanning signal Scan1 of the first scanning terminal S1 controls the first transistor M1 to be turned on, the second scanning signal Scan2 of the second scanning terminal S2 controls the second transistor M2 to be turned on, the third scanning signal Scan3 of the third scanning terminal S3 controls the third transistor M3 to be turned on, the fourth scanning signal Scan4 of the fourth scanning terminal controls the initialization transistor M8 to be turned on, and the fifth scanning signal Scan5 of the fifth scanning terminal S5 controls the anode reset transistor M9 to be turned on and controls other transistors to be turned off so that the reset signal Vref of the reset signal terminal REF is transmitted to the first node N1 through the turned-on first transistor M1 to reset the first node N1; and at the same time, the reset signal Vref is stored in the storage capacitor Cst to reset the storage capacitor Cst; the reset signal Vref is transmitted from the first node N1 to the first electrode (the third node N3) of the drive transistor T through the turned-on second transistor M2 to reset the first electrode of the drive transistor T; the reset signal Vref of the reset signal terminal REF is transmitted to the second node N2 through the turned-on third transistor M3 to reset the gate of the drive transistor T; the reset signal Vref of the reset signal terminal REF is transmitted to the second electrode of the drive transistor T through the turned-on initialization transistor M8 to reset the second electrode of the drive transistor T; and the reset signal Vref of the reset signal terminal REF is transmitted to the anode of the light-emitting element 40 through the turned-on anode reset transistor M9 to reset the anode of the light-emitting element 40. In this manner, the gate, the first electrode, and the second electrode of the drive transistor T and the anode of the light-emitting element 40 can be reset at the same time in the reset stage T1 so that in the reset stage of each driving cycle, the drive transistor T remains in the non-bias state so that the hysteresis effect of the drive transistor T can be prevented from affecting the writing of the data signal, and the potential written to the anode of the light-emitting element 40 in the previous driving cycle can be cleared to prevent the signal in the previous driving cycle from affecting the luminous brightness of the light-emitting element 40 in the current driving cycle, improving the light-emitting effect of the light-emitting element 40.

It is to be understood that in the data write stage T2, the sixth scanning signal Scan6 of the sixth scanning terminal S6 controls the data write transistor M6 and the threshold compensation transistor M7 to be turned on, and the first scanning signal Scan1 of the first scanning terminal S1 controls the first transistor M1 to remain on and controls other transistors to be in the off state so that the operation principle in the data write stage T2 is similar to the operation principle in the data write stage T2 in the preceding embodiment and is not repeated herein.

Similarly, in the light emission stage T3, the light emission control signal Emit of the light emission control terminal Em controls the first light emission control transistor M4 and the second light emission control transistor M5 to be in the on state, and the second scanning signal Scan2 of the second scanning terminal S2 controls the second transistor M2 to be in the on state and controls other transistors to be in the off state so that the operation principle of the light emission stage T3 is similar to the operation principle of the light emission stage T3 in the preceding embodiment and is not repeated herein.

Correspondingly, when the pixel circuit includes the anode reset transistor, the channel type of each transistor in the pixel circuit may be designed according to actual requirements, to achieve the object of reducing the number of the signal terminals in the pixel circuit.

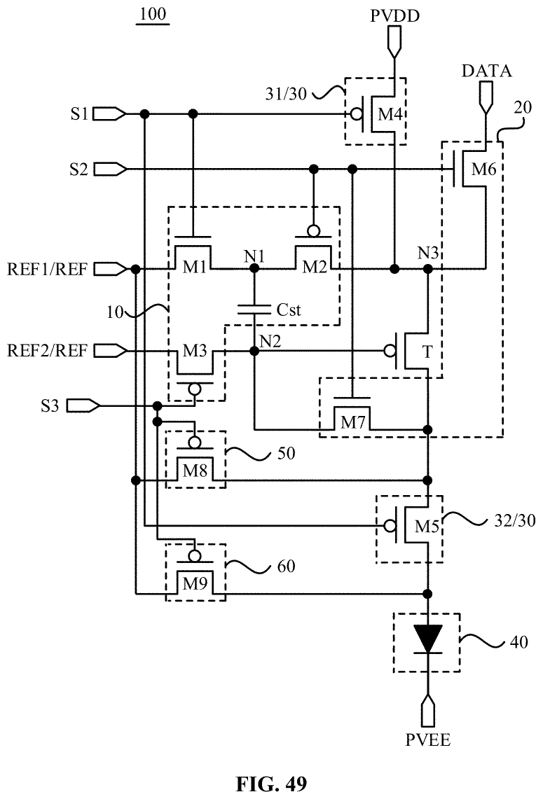

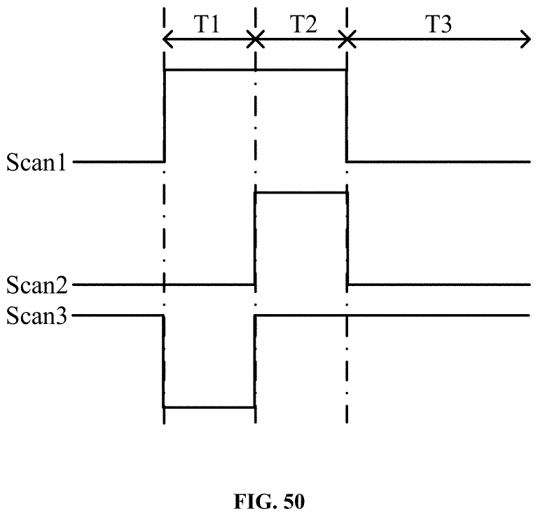

In an embodiment, FIG. 49 is a specific circuit diagram of another pixel circuit according to an embodiment of the present disclosure, and FIG. 50 is a driving timing diagram of a pixel circuit according to an embodiment of the present disclosure. In conjunction with FIGS. 49 and 50, a channel type of the anode reset transistor M9 is the same as the channel type of the third transistor M3 or the second transistor M2; in this case, the third scanning terminal S3 may be reused as the fifth scanning terminal so that in the reset stage T1, the third scanning signal Scan3 of the third scanning terminal S3 can control the third transistor M3 and the anode reset transistor M9 to be in the on state at the same time.

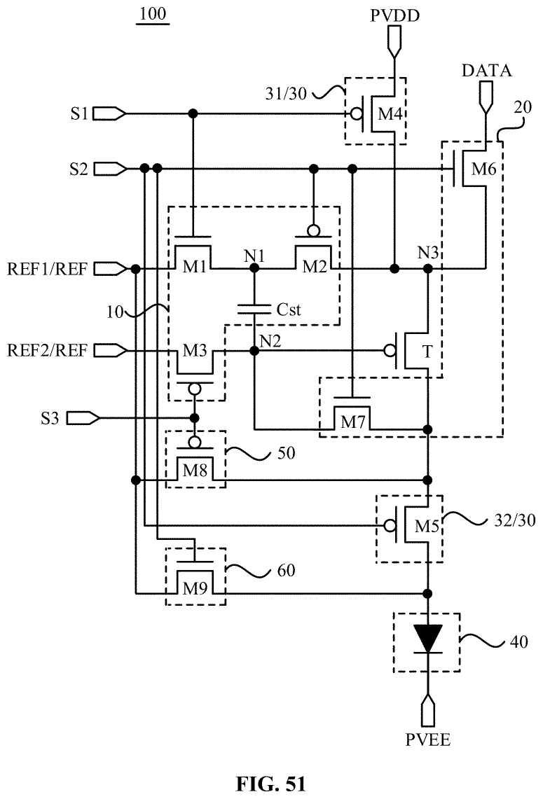

In an embodiment, in conjunction with FIGS. 51 and 50, the channel type of the anode reset transistor M9 may be different from the channel type of the second transistor M2; in this case, the second scanning terminal S2 may be reused as the fifth scanning terminal so that in the reset stage T1, the second scanning signal Scan2 of the second scanning terminal S2 may control the second transistor M2 to be turned on and control the anode reset transistor M9 to be turned off; in the data write stage T2, the second scanning signal Scan2 of the second scanning terminal S2 may control the anode reset transistor M9 to be turned on and control the second transistor M2 to be turned off; in the light emission stage T3, the second scanning signal Scan2 of the second scanning terminal S2 may control the second transistor M2 to be turned on and control the anode reset transistor M9 to be turned off.

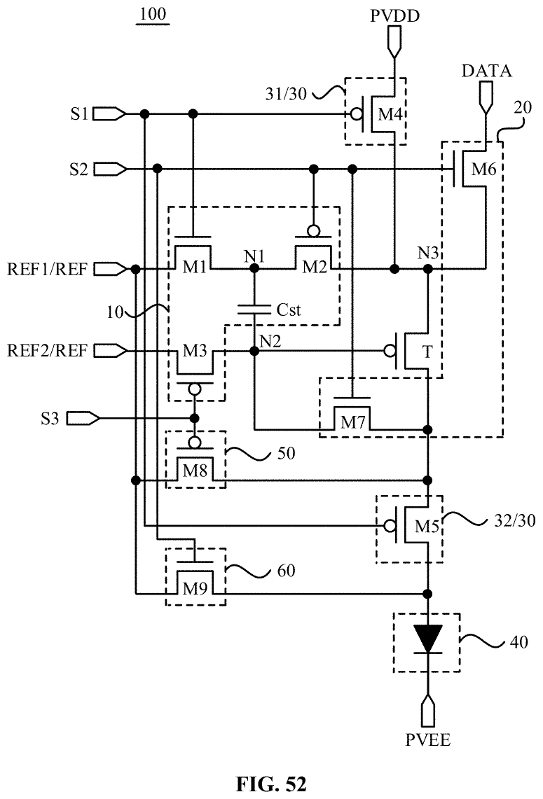

In an embodiment, in conjunction with FIGS. 52 and 50, the channel type of the anode reset transistor M9 may be the same as the channel type of the first transistor M1; in this case, the first scanning terminal S1 may be reused as the fifth scanning terminal so that in the reset stage T1, the first scanning signal Scan1 of the first scanning terminal S1 may control the first transistor M1 and the anode reset transistor M9 to be in the on state at the same time; in the data write stage T2, the first scanning signal Scan1 of the first scanning terminal S1 may control the first transistor M1 and the anode reset transistor M9 to remain on at the same time; in the light emission stage T3, the first scanning terminal S1 may be reused as the fifth scanning terminal so that in the reset stage T1, the first scanning signal Scan1 of the first scanning terminal S1 can control the first transistor M1 and the anode reset transistor M9 to be in the off state at the same time.

In this manner, the anode reset transistor can be turned on in the reset stage and/or the data write stage so that the reset signal of the reset signal terminal is transmitted to the anode of the light-emitting element through the turned-on anode reset transistor to reset the light-emitting element; and in the light emission stage, the anode reset transistor is turned off so that it is ensured that the drive current generated by the drive transistor is provided to the anode of the light-emitting element, and thus the light-emitting element can accurately present light with a corresponding brightness.

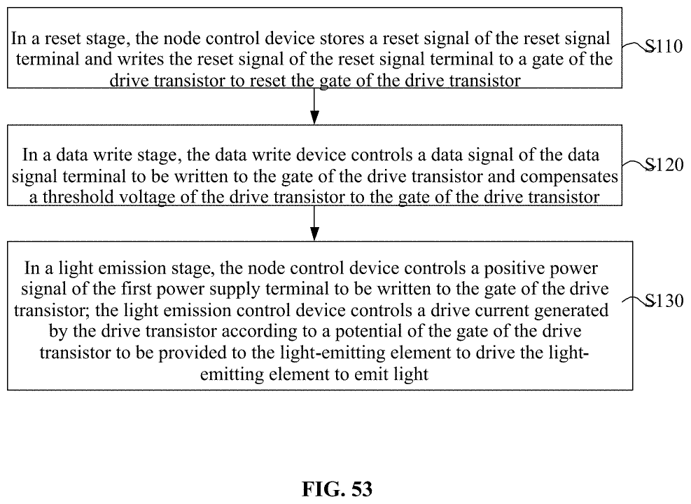

Based on the same inventive concept, the embodiments of the present disclosure further provide a driving method of a pixel circuit. The driving method of a pixel circuit may be used for driving the pixel circuit provided in the embodiments of the present disclosure. As shown in FIG. 1, the pixel circuit 100 may include the drive transistor T, the node control device 10, the data write device 20, the light emission control device 30, the light-emitting element 40, the reset signal terminal REF, the data signal terminal DATA, and the first power supply terminal PVDD. FIG. 53 is a flowchart of a driving method of a pixel circuit according to an embodiment of the present disclosure. As shown in FIG. 53, the driving method of a pixel circuit includes steps described below.

In S110, in a reset stage, the node control device stores a reset signal of the reset signal terminal and writes the reset signal of the reset signal terminal to a gate of the drive transistor to reset the gate of the drive transistor.

In S120, in a data write stage, the data write device controls a data signal of the data signal terminal to be written to the gate of the drive transistor and compensates a threshold voltage of the drive transistor to the gate of the drive transistor.

In S130, in a light emission stage, the node control device controls a positive power signal of the first power supply terminal to be written to the gate of the drive transistor; the light emission control device controls a drive current generated by the drive transistor according to a potential of the gate of the drive transistor to be provided to the light-emitting element to drive the light-emitting element to emit light.

Therefore, the node control device writes the power signal of the first power supply terminal to the gate of the drive transistor in the light emission stage, and the potential of the gate of the drive transistor is raised. In this manner, the drive transistor can provide a corresponding drive current according to the potential of the gate of the drive transistor so that the light-emitting element can present corresponding brightness just by writing data signals that vary within a relatively small voltage range to the gate of the drive transistor in the data write stage, which is conductive to the low power consumption of the pixel circuit and thus conductive to the low power consumption of the display panel and the display device. At the same time, when a voltage of the data signal written to the gate of the drive transistor in the data write stage is relatively small, the data signal with the relatively small voltage can be quickly written to the gate of the drive transistor so that the time for writing the data signal can be shortened and thus the problem of lack of data write time during high-frequency driving can be improved, improving the display effect of the display panel. In addition, the node control device provides the reset signal of the reset signal terminal to the gate of the drive transistor to reset the gate of the drive transistor in the reset stage so that it is ensured that the data write device can write the data signal of the data signal terminal to the gate of the drive transistor in the data write stage. Moreover, when writing the data signal to the gate of the drive transistor in the data write stage, the data write device compensates the threshold voltage of the drive transistor to the gate of the drive transistor so that the drive current generated by the drive transistor according to the potential of the gate of the drive transistor is independent of the threshold voltage of the drive transistor. In this manner, when the light emission control device controls the drive current generated by the drive transistor according to the potential of the gate of the drive transistor to be provided to the light-emitting element to drive the light-emitting element to emit light in the light emission stage, the fluctuation of the threshold voltage of the drive transistor can be prevented from affecting the luminous brightness of the light-emitting element, which is conductive to improving the display uniformity of the display panel.

In an embodiment, the driving method of a pixel circuit further includes in the reset stage, controlling, by the node control device, the reset signal of the reset signal terminal to be written to a first electrode of the drive transistor to reset the first electrode of the drive transistor. In this manner, in the reset stage, the gate and the first electrode of the drive transistor can be reset at the same time so that in the reset stage of each driving cycle, the gate and the first electrode of the drive transistor can be in a fixed state to prevent the hysteresis effect of the drive transistor, which is conductive to the writing of the data signal in the data write stage, improving the accuracy of the data signal written to the gate of the drive transistor, improving the accuracy of the luminous brightness of the light-emitting element, and thus improving the display effect of the display panel.

In an embodiment, the light emission stage specifically includes receiving, by the node control device, the power signal of the first power supply terminal through the light emission control device and writing the power signal to the gate of the drive transistor. In this manner, in the light emission stage, the node control device can write the power signal of the first power supply terminal to the gate of the drive transistor, which is conductive to simplifying the structure of the pixel circuit and simplifying the driving method of a pixel circuit.

In an embodiment, as shown in FIG. 3, the pixel circuit 100 further includes the first scanning terminal S1 and the second scanning terminal S2; the node control device 10 includes the first transistor M1, the second transistor M2, and the storage capacitor Cst; the gate of the first transistor M1 is electrically connected to the first scanning terminal S1, and the gate of the second transistor M2 is electrically connected to the second scanning terminal S3; the second electrode of the first transistor M1, the first electrode of the second transistor M2, and the first electrode plate of the storage capacitor Cst are electrically connected to the first node N1, the second electrode plate of the storage capacitor Cst and the gate of the drive transistor T are electrically connected to the second node N2, and the second electrode of the second transistor M2 and the first electrode of the drive transistor T are electrically connected to the third node N3.

In this case, the reset stage specifically includes controlling, by the first scanning signal Scan1 of the first scanning terminal S1, the first transistor M1 to be turned on, controlling, by the second scanning signal Scan2 of the second scanning terminal S2, the second transistor M2 to be turned on, writing the reset signal Vref1 of the reset signal terminal REF to the first node N1 through the first transistor M1 to reset the first node N1, coupling the reset signal Vref1 of the reset signal terminal REF to the second node N2 through the storage capacitor Cst to reset the gate of the drive transistor T, and writing the reset signal Vref1 of the reset signal terminal REF to the third node N3 through the second transistor M2 to reset the third node N3. In this manner, the first node N1 can be reset by controlling the first transistor M1 to be turned on, the second node N2 can be reset through the coupling effect of the storage capacitor Cst; and the third node N3 can be reset by controlling the second transistor M2 to be turned on.

In an embodiment, as shown in FIG. 10, the pixel circuit 100 further includes the first scanning terminal S1, the second scanning terminal S2, and the third scanning terminal S3; the node control device 10 includes the first transistor M1, the second transistor M2, the third transistor M3, and the storage transistor Cst; the gate of the first transistor M1 is electrically connected to the first scanning terminal S1, the gate of the second transistor M2 is electrically connected to the second scanning terminal S2, and the gate of the third transistor M3 is electrically connected to the third scanning terminal S3; the second electrode of the first transistor M1, the first electrode of the second transistor M2, and the first electrode plate of the storage capacitor Cst are electrically connected to the first node N1, the second electrode plate of the storage capacitor Cst and the gate of the drive transistor T are electrically connected to the second node N2, and the second electrode of the second transistor M2 and the first electrode of the drive transistor T are electrically connected to the third node N3; the first electrode of the third transistor M3 is electrically connected to the reset signal terminal REF, and the second electrode of the third transistor M3 is electrically connected to the gate of the drive transistor T.

In this case, the reset stage specifically includes controlling, by the first scanning signal Scan1 of the first scanning terminal S1, the first transistor M1 to be turned on, controlling, by the second scanning signal Scan2 of the second scanning terminal S2, the second transistor M2 to be turned on, writing the reset signal Vref of the reset signal terminal REF to the first node N1 through the first transistor M1 to reset the first node N1, writing the reset signal Vref of the rest signal terminal REF to the third node N3 through the second transistor M2 to reset the third node N3, controlling, by the third scanning signal Scan3 of the third scanning terminal S3, the third transistor M3 to be turned on, and writing the reset signal Vref of the reset signal terminal REF to the gate of the drive transistor T to reset the gate of the drive transistor T. In this manner, the first node N1 can be reset by controlling the first transistor M1 to be turned on, the second node N2 can be reset by controlling the third transistor M3 to be turned on, and the third node N3 can be rest by controlling the second transistor M2 to be turned on.

In an embodiment, as shown in FIG. 12, the pixel circuit 100 further includes the initialization device 50 and the fourth scanning terminal S4; the initialization device 50 includes the initialization transistor M8; the gate of the initialization transistor M8 is electrically connected to the fourth scanning terminal S4, the first electrode of the initialization transistor M8 is electrically connected to the reset signal terminal REF, and the second electrode of the initialization transistor M8 is electrically connected to the second node N2.

In this case, the reset stage further includes controlling, by the fourth scanning signal Scan4 of the fourth scanning terminal S4, the initialization transistor M8 to be turned on, and writing the reset signal Vref of the reset signal terminal REF to the second electrode of the drive transistor T through the initialization transistor M8 to initialize the second electrode of the drive transistor T. In this manner, in the reset stage, the gate, the first electrode, and the second electrode of the drive transistor T can be reset at the same time so that the gate, the first electrode, and the second electrode of the drive transistor T can be in a fixed state to prevent the hysteresis effect of the drive transistor T, which is conductive to the writing of the data signal in the data write stage, improving the accuracy of the data signal written to the gate of the drive transistor T, improving the accuracy of the luminous brightness of the light-emitting element 40, and thus improving the display effect of the display panel.

In an embodiment, with continued reference to FIG. 12, the pixel circuit 100 further includes the second power supply terminal PVEE, the first light emission control terminal Em1, and the second light emission control terminal Em2; the light emission control device 30 includes the first light emission control transistor M4 and the second light emission control transistor M5; the first electrode of the first light emission control transistor M4 is electrically connected to the first power supply terminal PVDD, and the second electrode of the first light emission control transistor M4 is electrically connected to the third node N3 or the first node N1; the gate of the first light emission control transistor M4 is electrically connected to the first light emission control terminal Em1; the gate of the second light emission control transistor M5 is electrically connected to the second light emission control terminal Em2, the first electrode of the second light emission control transistor M5 is electrically connected to the second electrode of the drive transistor T, the second electrode of the second light emission control transistor M5 is electrically connected to the anode of the light-emitting element 40, and the cathode of the light-emitting element 40 is electrically connected to the second power supply terminal PVEE.

In this case, the reset stage further includes controlling, by the second light emission control signal Emit2 of the second light emission control terminal Em2, the second light emission control transistor M5 to be turned on, and transmitting the reset signal Vref of the reset signal terminal REF to the anode of the light-emitting element 40 sequentially through the initialization transistor M8 and the second light emission control transistor M5 to reset the anode of the light-emitting element 40. In this manner, in the reset stage, the anode of the light-emitting element 40 can be reset to clear the signal written to the anode of the light-emitting element 40 in the previous driving cycle, preventing the signal in the previous driving cycle from affecting the luminous brightness of the light-emitting element 40 in the current driving cycle and thus improving the light-emitting effect of the light-emitting element 40.

In an embodiment, as shown in FIG. 47, the pixel circuit 100 may further include the anode reset device 60 and the fifth scanning terminal S5; the anode reset device 60 includes the anode reset transistor M9, where the gate of the anode reset transistor M9 is electrically connected to the fifth scanning terminal S5, the first electrode of the anode reset transistor M9 is electrically connected to the reset signal terminal REF, and the second electrode of the anode reset transistor M9 is electrically connected to the anode of the light-emitting element 40.

In this case, the reset stage further includes controlling, by the fifth scanning signal Scan5 of the fifth scanning terminal S5, the anode reset transistor M9 to be turned on, and writing the reset signal Vref of the reset signal terminal REF to the anode of the light-emitting element 40 through the anode reset transistor M9 to reset the anode of the light-emitting element 40; and/or the data write stage further includes controlling, by the fifth scanning signal Scan5 of the fifth scanning terminal S5, the anode reset transistor M9 to be turned on, and writing the reset signal Vref of the reset signal terminal REF to the anode of the light-emitting element 40 through the anode reset transistor M9 to keep the anode of the light-emitting element 40 as the reset signal Vref In this manner, the anode reset transistor M9 is controlled to be turned on in the reset stage and/or the data write stage so that the reset signal Vref can be transmitted to the anode of the light-emitting element 40 to reset the anode of the light-emitting element 40.

Based on the same inventive concept, the embodiments of the present disclosure further provide a display panel including the pixel circuit provided in the embodiments of the present disclosure. Therefore, the display panel provided in the embodiments of the present disclosure includes the pixel circuit provided in the embodiments of the present disclosure and can achieve the beneficial effects of the pixel circuit provided in the embodiments of the present disclosure, which is not described in detail below.

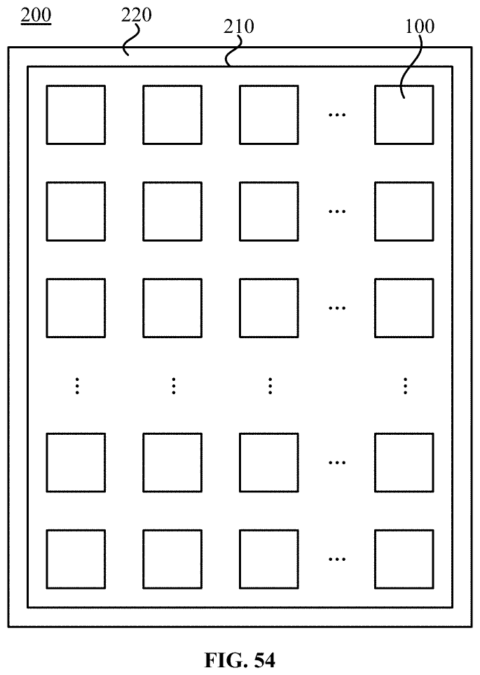

In an embodiment, FIG. 54 is a structure diagram of a display panel according to an embodiment of the present disclosure. As shown in FIG. 54, a display panel 200 includes a display region 210 and a non-display region 220, where the display region 210 includes pixel circuits 100 arranged in an array.

Based on the same inventive concept, the embodiments of the present disclosure further provide a display device. The display device includes the display panel provided in the embodiments of the present disclosure, so the display device also has the beneficial effects of the display panel provided in the embodiments of the present disclosure, and the same portions can be understood with reference to the preceding description and are not described in detail below.

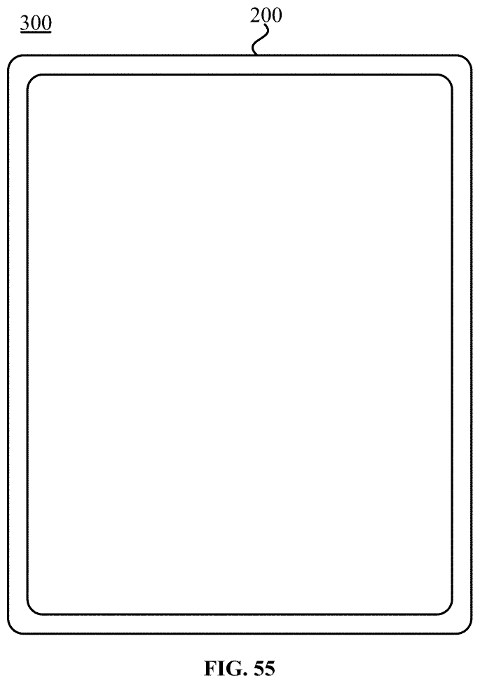

In an embodiment, FIG. 55 is a structure diagram of a display device according to an embodiment of the present disclosure. As shown in FIG. 55, a display device 300 provided in the embodiments of the present disclosure includes the display panel 200 provided in the embodiments of the present disclosure. The display device 300 may be, for example, a touch display screen, a mobile phone, a tablet, a laptop, a television or any electronic device having a display function.

What is claimed is:

1. A pixel circuit, comprising:
a drive transistor, a node control device, a data write device, a light emission control device, a light-emitting element, a reset signal terminal, a data signal terminal, and a first power supply terminal,
wherein the node control device is configured to: in a reset stage, store a reset signal of the reset signal terminal and reset a gate of the drive transistor; and
in a light emission stage, control a power signal of the first power supply terminal to be written to the gate of the drive transistor;
the data write device is configured to, in a data write stage, write a data signal of the data signal terminal to the gate of the drive transistor and compensate a threshold voltage of the drive transistor to the gate of the drive transistor; and
the light emission control device is configured to, in the light emission stage, control a drive current generated by the drive transistor according to a potential of the gate of the drive transistor to be provided to the light-emitting element to drive the light-emitting element to emit light.

2. The pixel circuit of claim 1, wherein the node control device is further configured to, in the reset stage, write the reset signal of the reset signal terminal to a first electrode of the drive transistor.

3. The pixel circuit of claim 2, further comprising:
a second power supply terminal;
wherein the light emission control device comprises a first light emission control unit and a second light emission control unit; and
wherein the node control device is electrically connected to the reset signal terminal, the first light emission control unit, the first electrode of the drive transistor, and the gate of the drive transistor, respectively;
the first light emission control unit is electrically connected to the first electrode of the drive transistor and the first power supply terminal; the second light emission control unit is electrically connected to a second electrode of the drive transistor and an anode of the light-emitting element, respectively; and
a cathode of the light-emitting element is electrically connected to the second power supply terminal.

4. The pixel circuit of claim 3, further comprising:
a first scanning terminal and a second scanning terminal;
wherein the node control device comprises a first transistor, a second transistor, and a storage capacitor,
wherein a gate of the first transistor is electrically connected to the first scanning terminal, and a gate of the second transistor is electrically connected to the second scanning terminal;
a first electrode of the first transistor is electrically connected to the reset signal terminal;
a second electrode of the first transistor, a first electrode of the second transistor, and a first electrode plate of the storage capacitor are electrically connected to a first node;
a second electrode plate of the storage capacitor and the gate of the drive transistor are electrically connected to a second node; a second electrode of the second transistor and the first electrode of the drive transistor are electrically connected to a third node; and
wherein the first light emission control unit and the node control device are electrically connected to the first node; or the first light emission control unit and the node control device are electrically connected to the third node.

5. The pixel circuit of claim 4, further comprising:
a third scanning terminal;
wherein the node control device further comprises a third transistor;
a gate of the third transistor is electrically connected to the third scanning terminal, a first electrode of the third transistor is electrically connected to the reset signal terminal, and a second electrode of the third transistor is electrically connected to the second node;
wherein the reset signal terminal comprises a first reset signal terminal and a second reset signal terminal,
wherein the reset signal terminal electrically connected to the first electrode of the first transistor is the first reset signal terminal; and the reset signal terminal electrically connected to the first electrode of the third transistor is the second reset signal terminal;
wherein a voltage of a first reset signal at the first reset signal terminal is greater than a voltage of a second reset signal at the second reset signal terminal; and
wherein the drive transistor is a P-type transistor, a threshold voltage of the drive transistor is Vth, a voltage of the first reset signal is Vref1 and a voltage of the second reset signal is Vref2,
wherein 0<Vref2−Vref1≤|Vth|.

6. The pixel circuit of claim 4, further comprising:
a light emission control terminal;
wherein the first light emission control unit comprises a first light emission control transistor,
wherein a gate of the first light emission control transistor is electrically connected to the light emission control terminal, a first electrode of the first light emission control transistor is electrically connected to the first power supply terminal, and a second electrode of the first light emission control transistor is electrically connected to the first node or the third node; and
the second light emission control unit comprises a second light emission control transistor,
wherein a gate of the second light emission control transistor is electrically connected to the light emission control terminal, a first electrode of the second light emission control transistor is electrically connected to the second electrode of the drive transistor, and a second electrode of the second light emission control transistor is electrically connected to the anode of the light-emitting element.

7. The pixel circuit of claim 6, further comprising:
an initialization device;
wherein a first terminal of the initialization device is electrically connected to the reset signal terminal, a second terminal of the initialization device is electrically connected to the second electrode of the drive transistor, and the initialization device is configured to write the reset signal of the reset signal terminal to the second electrode of the drive transistor.

8. The pixel circuit of claim 7, further comprising:
a fourth scanning terminal;
wherein the initialization device comprises an initialization transistor; a gate of the initialization transistor is electrically connected to the fourth scanning terminal, a first electrode of the initialization transistor is electrically connected to the reset signal terminal, and a second electrode of the initialization transistor is electrically connected to the second electrode of the drive transistor.

9. The pixel circuit of claim 6, further comprising:
an anode reset device, a fifth scanning terminal and a third scanning terminal,
wherein a first terminal of the anode reset device is electrically connected to the reset signal terminal, a second terminal of the anode reset device is electrically connected to the anode of the light-emitting element, and the anode reset device is configured to write the reset signal of the reset signal terminal to the anode of the light-emitting element;
wherein the anode reset device comprises an anode reset transistor;
wherein a gate of the anode reset transistor is electrically connected to the fifth scanning terminal, a first electrode of the anode reset transistor is electrically connected to the reset signal terminal, and a second electrode of the anode reset transistor is electrically connected to the anode of the light-emitting element;
wherein the node control device further comprises a third transistor; a gate of the third transistor is electrically connected to the third scanning terminal, a first electrode of the third transistor is electrically connected to the reset signal terminal, and a second electrode of the third transistor is electrically connected to the second node; and
a channel type of the anode reset transistor is the same as a channel type of any one of the third transistor, the second transistor, or the first transistor.

10. The pixel circuit of claim 4, further comprising:
a sixth scanning terminal;
wherein the data write device comprises a data write transistor and a threshold compensation transistor,
wherein a gate of the data write transistor and a gate of the threshold compensation transistor are both electrically connected to the sixth scanning terminal;
a first electrode of the data write transistor is electrically connected to the data signal terminal, and a second electrode of the data write transistor is electrically connected to the first electrode of the drive transistor; a first electrode of the threshold compensation transistor is electrically connected to the second electrode of the drive transistor, and a second electrode of the threshold compensation transistor is electrically connected to the gate of the drive transistor;
wherein a channel type of the second transistor is different from a channel type of the data write transistor; and
wherein the second scanning terminal is reused as the sixth scanning terminal.

11. A driving method of a pixel circuit, wherein the driving method of a pixel circuit is used for driving the pixel circuit, wherein the pixel circuit comprises a drive transistor, a node control device, a data write device, a light emission control device, a light-emitting element, a reset signal terminal, a data signal terminal, and a first power supply terminal; and wherein the driving method of the pixel circuit comprises:
in a reset stage, storing, by the node control device, a reset signal of the reset signal terminal and writing the reset signal of the reset signal terminal to a gate of the drive transistor to reset the gate of the drive transistor;
in a data write stage, controlling, by the data write device, a data signal of the data signal terminal to be written to the gate of the drive transistor and compensating a threshold voltage of the drive transistor to the gate of the drive transistor; and
in a light emission stage, controlling, by the node control device, a positive power signal of the first power supply terminal to be written to the gate of the drive transistor; and
controlling, by the light emission control device, a drive current generated by the drive transistor according to a potential of the gate of the drive transistor to be provided to the light-emitting element to drive the light-emitting element to emit light.

12. The driving method of a pixel circuit of claim 11, further comprising:
in the reset stage, controlling, by the node control device, the reset signal of the reset signal terminal to be written to a first electrode of the drive transistor to reset the first electrode of the drive transistor.

13. The driving method of a pixel circuit of claim 12, wherein in the light emission stage, the driving method specifically comprises:
receiving, by the node control device, a power signal of the first power supply terminal through the light emission control device and writing the power signal to the gate of the drive transistor.

14. The driving method of a pixel circuit of claim 13, wherein the pixel circuit further comprises:
a first scanning terminal and a second scanning terminal; the node control device comprises a first transistor, a second transistor, and a storage capacitor, wherein a gate of the first transistor is electrically connected to the first scanning terminal, and a gate of the second transistor is electrically connected to the second scanning terminal;
a second electrode of the first transistor, a first electrode of the second transistor, and a first electrode plate of the storage capacitor are electrically connected to a first node, a second electrode plate of the storage capacitor and the gate of the drive transistor are electrically connected to a second node, and a second electrode of the second transistor and the first electrode of the drive transistor are electrically connected to a third node; and
wherein in the reset stage, the driving method specifically comprises:
controlling, by a first scanning signal of the first scanning terminal, the first transistor to be turned on;
controlling, by a second scanning signal of the second scanning terminal, the second transistor to be turned on;
writing the reset signal of the reset signal terminal to the first node through the first transistor to reset the first node, and coupling the reset signal of the reset signal terminal to the second node through the storage capacitor to reset the gate of the drive transistor; and
writing the reset signal of the reset signal terminal to the third node through the second transistor to reset the third node.

15. The driving method of a pixel circuit of claim 13, wherein the pixel circuit further comprises:
a first scanning terminal, a second scanning terminal, and a third scanning terminal;
the node control device comprises:
a first transistor, a second transistor, a third transistor, and a storage capacitor, wherein a gate of the first transistor is electrically connected to the first scanning terminal, a gate of the second transistor is electrically connected to the second scanning terminal, and a gate of the third transistor is electrically connected to the third scanning terminal;
a second electrode of the first transistor, a first electrode of the second transistor, and a first electrode plate of the storage capacitor are electrically connected to a first node, a second electrode plate of the storage capacitor and the gate of the drive transistor are electrically connected to a second node, and a second electrode of the second transistor and the first electrode of the drive transistor are electrically connected to a third node;
a first electrode of the third transistor is electrically connected to the reset signal terminal, and a second electrode of the third transistor is electrically connected to the gate of the drive transistor; and
wherein in the reset stage, the driving method specifically comprises:
controlling, by a first scanning signal of the first scanning terminal, the first transistor to be turned on;
controlling, by a second scanning signal of the second scanning terminal, the second transistor to be turned on;
writing the reset signal of the reset signal terminal to the first node through the first transistor to reset the first node;
writing the reset signal of the reset signal terminal to the third node through the second transistor to reset the third node;
controlling, by a third scanning signal of the third scanning terminal, the third transistor to be turned on; and
writing the reset signal of the reset signal terminal to the gate of the drive transistor to reset the gate of the drive transistor.

16. The driving method of a pixel circuit of claim 15, wherein the pixel circuit further comprises:
an initialization device and a fourth scanning terminal, wherein the initialization device comprises an initialization transistor;
a gate of the initialization transistor is connected to the fourth scanning terminal, a first electrode of the initialization transistor is electrically connected to the reset signal terminal, and a second electrode of the initialization transistor is electrically connected to the second node;
wherein in the reset stage, the driving method further comprises:
controlling, by a fourth scanning signal of the fourth scanning terminal, the initialization transistor to be turned on; and
writing the reset signal of the reset signal terminal to a second electrode of the drive transistor through the initialization transistor to initialize the second electrode of the drive transistor.

17. The driving method of a pixel circuit of claim 16, wherein the pixel circuit further comprises:
second power supply terminal, a first light emission control terminal, and a second light emission control terminal;
the light emission control device comprises a first light emission control transistor and a second light emission control transistor, wherein a first electrode of the first light emission control transistor is electrically connected to the first power supply terminal, and a second electrode of the first light emission control transistor is electrically connected to the third node or the first node;
a gate of the first light emission control transistor is electrically connected to the first light emission control terminal;
a gate of the second light emission control transistor is electrically connected to the second light emission control terminal, a first electrode of the second light emission control transistor is electrically connected to the second electrode of the drive transistor, a second electrode of the second light emission control transistor is electrically connected to an anode of the light-emitting element, and a cathode of the light-emitting element is electrically connected to the second power supply terminal;
wherein in the reset stage, the driving method further comprises:
controlling, by a second light emission control signal of the second light emission control terminal, the second light emission control transistor to be turned on; and
transmitting the reset signal of the reset signal terminal to the anode of the light-emitting element sequentially through the initialization transistor and the second light emission control transistor to reset the anode of the light-emitting element.

18. The driving method of a pixel circuit of claim 15, wherein the pixel circuit further comprises:
an anode reset device and a fifth scanning terminal, wherein the anode reset device comprises:
an anode reset transistor, wherein a gate of the anode reset transistor is electrically connected to the fifth scanning terminal, a first electrode of the anode reset transistor is electrically connected to the reset signal terminal, and a second electrode of the anode reset transistor is electrically connected to an anode of the light-emitting element;
wherein in the reset stage, the driving method further comprises:
controlling, by a fifth scanning signal of the fifth scanning terminal, the anode reset transistor to be turned on; and
writing the reset signal of the reset signal terminal to the anode of the light-emitting element through the anode reset transistor to reset the anode of the light-emitting element;
and the data write stage further comprises:
controlling, by a fifth scanning signal of the fifth scanning terminal, the anode reset transistor to be turned on; and
writing the reset signal of the reset signal terminal to the anode of the light-emitting element through the anode reset transistor to keep the anode of the light-emitting element connected to the reset signal.

19. A display panel, comprising:
a pixel circuit, wherein the pixel circuit comprises:
a drive transistor, a node control device, a data write device, a light emission control device, a light-emitting element, a reset signal terminal, a data signal terminal, and a first power supply terminal,
wherein the node control device is configured to: in a reset stage, store a reset signal of the reset signal terminal and reset a gate of the drive transistor; and in a light emission stage, control a power signal of the first power supply terminal to be written to the gate of the drive transistor;
the data write device is configured to, in a data write stage, write a data signal of the data signal terminal to the gate of the drive transistor and compensate a threshold voltage of the drive transistor to the gate of the drive transistor; and
the light emission control device is configured to, in the light emission stage, control a drive current generated by the drive transistor according to a potential of the gate of the drive transistor to be provided to the light-emitting element to drive the light-emitting element to emit light.

20. A display device, comprising the display panel of claim 19.
